(19) United States
(12) Patent Application Publication
(10) Pub. No.: US 2024/0311623 A1
(43) Pub. Date: Sep. 19, 2024

(54) BUILDING TIME-DECAYED LINE GRAPHS FOR DIRECT EMBEDDING OF CONTINUOUS-TIMED INTERACTIONS IN GENERATING TIME-AWARE RECOMMENDATIONS

(71) Applicant: Adobe Inc., San Jose, CA (US)

(72) Inventors: Ryan Rossi, Santa Clara, CA (US); Eunyee Koh, San Jose, CA (US); Jane Hoffswell, Seattle, WA (US); Nedim Lipka, Santa Clara, CA (US); Shunan Guo, San Jose, CA (US); Sudhanshu Chanpuriya, Amherst, MA (US); Sungchul Kim, San Jose, CA (US); Tong Yu, San Jose, CA (US)

(21) Appl. No.: 18/183,387

(22) Filed: Mar. 14, 2023

(51) Int. Cl. G06N 3/049

(52) U.S. Cl. CPC G06N 3/049

(57) ABSTRACT

The present disclosure relates to systems, non-transitory computer-readable media, and methods for building time-decayed line graphs from temporal graph networks for efficiently and accurately generating time-aware recommendations. For example, the time-decayed line graph system creates a line graph of the temporal graph network by deriving interaction nodes from temporal edges (e.g., timed interactions) and connecting interactions that share an endpoint node. Then, the time-decayed line graph system determines the edge weights in the line graph based on differences in time between interactions, with interactions that occur closer together in time being connected with higher weights. Notably, by using this method, the derived time-decayed line graph directly represents topological proximity and temporal proximity. Upon generating the time-decayed line graphs, the system performs downstream predictive modeling such as predicted edge classifications and/or temporal link predictions.

### BACKGROUND

Recent years have seen significant improvements in hardware and software platforms for modeling interactions between computing devices across computer networks. For example, some conventional systems utilize temporal networks, which are graphs augmented with a time value for each edge, to model a variety of phenomena involving timed interactions. Additionally, conventional systems utilize machine learning models with temporal networks to generate various classifications or predictions. Conventional machine learning models generate these predictions using vector representations, or embeddings, for the nodes of the temporal network. For example, most conventional systems generate node embeddings that are utilized by various machine learning models to generate predictions or classifications. In a few cases, some conventional systems indirectly generate edge embeddings by aggregating the node embeddings (e.g., by taking the entrywise product of the two node embeddings corresponding to an edge). In many cases, conventional systems also require discretized time representations. Notably, the conventional approaches of deriving node embeddings from temporal networks, indirectly deriving edge embeddings by aggregating node embeddings, and/or utilizing discretized time representations lead to deficiencies in system accuracy, efficiency, and flexibility.

For instance, as just discussed, most conventional systems are node representation-based, meaning that they focus on learning from node embeddings. However, node embeddings often do not include timestamped information contained within temporal network edges. Accordingly, conventional systems learn embeddings from nodes which contain indirect timestamp information. This approach can undermine the accuracy of resulting predictions.

In addition, many conventional systems fail to generate accurate representations of continuous-timed edges. To illustrate, many conventional systems treat time as discretized which results in lossy approximations of the actual timestamped edges (e.g., user interactions/events, webpage access, products purchased, features clicked on). Indeed, because most datasets comprise continuous-timed information, the assumption that time is discretized results in the loss of precise time information.

Further, conventional systems suffer from inflexibilities and inefficiencies. Conventional systems have focused on extending existing node embedding approaches for temporal networks. In particular, conventional systems generally return embeddings of nodes, so edge embeddings are calculated indirectly from the nodes. This inflexible, indirect approach is more applicable to discrete-time representations and provides lossy approximations of the actual timestamped edges. The rigidity of conventional techniques are suboptimal for time-aware classification or prediction tasks. Accordingly, conventional systems not only lead to poor predictive performance (low accuracy) but are also computationally expensive in terms of runtime and space requirements. Indeed, conventional systems often do not return directly usable encodings and thus often require expensive dimensionality reduction procedures, which adds increased complication and reduces efficiency.

These along with additional problems and issues exist with regard to conventional systems utilizing temporal networks.

### BRIEF SUMMARY

Embodiments of the present disclosure solve one or more of the foregoing or other problems in the art with systems, non-transitory computer-readable media, and methods for building time-decayed line graphs from temporal graph networks for efficiently and accurately generating time-aware recommendations. For example, to utilize a temporal network, the disclosed systems create a line graph of the temporal graph network by deriving interaction nodes from temporal edges (e.g., timed interactions) and connecting interactions that share an endpoint node. In addition, the disclosed systems set the edge weights in the line graph based on differences in time between interactions, with interactions that occur closer together in time being connected with higher weights. Indeed, from this derived graph (which directly represents topological proximity and temporal proximity) the disclosed systems generate temporal edge representations (e.g., continuous-time edge embeddings) for the original network. Upon generating the time-decayed line graphs, the disclosed systems generate downstream predictions such as predicted edge classifications and/or temporal link predictions. In this manner, the disclosed systems flexibly learn continuous-time edge embeddings to efficiently generate accurate, real-world time-aware recommendations.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a time-decayed line graph system operates in accordance with one or more embodiments.

FIG. 2 illustrates an overview diagram of the time-decayed line graph system performing predictive modeling for a temporal graph network in accordance with one or more embodiments.

FIG. 3 illustrates an overview of a time-decayed line graph system determining time-decayed edge weights from a temporal graph network in accordance with one or more embodiments.

FIG. 4 illustrates an overview of a time-decayed line graph system generating downstream predictive modeling for a time-decayed line graph in accordance with one or more embodiments.

FIG. 5 illustrates an example of a node distribution where the time-decayed line graph system captures the latent temporal structure of a temporal graph network in accordance with one or more embodiments.

FIG. 6 illustrates results of the time-decayed line graph system utilizing continuous-time edge embeddings to recover node communities in accordance with one or more embodiments.

FIG. 7 illustrates test results relating to accuracy in accordance with one or more embodiments.

FIG. 8 illustrates additional test results relating to predictive modeling in accordance with one or more embodiments.

FIGS. 9A-9C illustrates additional test results relating to accuracy in accordance with one or more embodiments.

FIG. 10 illustrates additional test results relating to runtime in accordance with one or more embodiments.

FIG. 11 illustrates test results relating to scalability in accordance with one or more embodiments.

FIG. 12 illustrates additional test results related to varying the time scale hyperparameter or normalization type in accordance with one or more embodiments.

FIG. 13 illustrates a schematic diagram of a time-decayed line graph system in accordance with one or more embodiments.

FIG. 14 illustrates a flowchart of a series of acts for generating downstream predictive modeling with a time-decayed line graph system in accordance with one or more embodiments.

FIG. 15 illustrates a block diagram of an example computing device in accordance with one or more embodiments.

### DETAILED DESCRIPTION

This disclosure describes one or more embodiments of a time-decayed line graph system that builds time-decayed line graphs from temporal graph networks for direct embedding of continuous-timed interactions in generating time-aware recommendations. For example, the time-decayed line graph system learns natural continuous-time edge embeddings and constructs time-decayed line graphs by composing nodes from each interaction on the temporal graph network. Moreover, in one or more embodiments the time-decayed line graph system derives edge embeddings from the continuous-time representation of the data and decays edge weights based on the difference in time between interactions. Indeed, in some implementations, the time-decayed line graph system directly forms embeddings for continuous-time temporal edges without supervision and without aggregating node embeddings. Upon generating the time-decayed line graphs, the system can perform a variety of downstream predictive modeling tasks such as generating predicted edge classifications and/or temporal link predictions.

To further illustrate, in one or more embodiments, the time-decayed line graph system generates a temporal graph network comprising multiple entity nodes and temporal interaction edges connecting the entity nodes. In particular, the time-decayed line graph system generates a temporal graph network that represents the relationships between entities over time that is comprised of entity nodes (representing entities) and temporal interaction edges (representing relationships with associated temporal information).

Furthermore, in one or more embodiments, the time-decayed line graph system constructs a time-decayed line graph from the temporal graph network by generating interaction nodes from temporal interaction edges of the temporal graph network and generating time-decayed weighted edges between the interaction nodes based on times (e.g., temporal information associated with) of the temporal interaction edges. Upon constructing the time-decayed line graph, in some implementations, the time-decayed line graph system generates a predicted edge classification and/or a temporal link prediction.

In one or more embodiments, the time-decayed line graph system generates continuous-time edge embeddings from the time-decayed line graph. For example, in one or more embodiments, the time-decayed line graph system generates temporal interaction edges reflecting continuous times corresponding to the entity interactions of the temporal line graph. Indeed, the time-decayed line graph system constructs the time-decayed line graph by generating the temporal interaction nodes and time-decayed weighted edges from the continuous times corresponding to the temporal interaction edges. In one or more embodiments, the time-decayed line graph system utilizes the continuous time edge embeddings to generate predicted edge classifications and/or temporal link predictions.

In one or more embodiments, the time-decayed line graph system generates a time-decayed weighted edge between interaction nodes based on determining that interaction edges are connected to the same (shared) entity node of the temporal graph network. Furthermore, in one or more embodiments, the time-decayed line graph system determines the time-decayed weight for the time-decayed weighted edges based on the differences in time between interactions, with interactions that occur closer together in time being connected with higher weights. For instance, the time-decayed line graph system generates a time-decayed weight for the time-decayed weighted edge that is inversely proportional to a difference between the interaction times of the temporal graph network.

In one or more implementations, the time-decayed line graph system generates temporal edge embeddings based on the interaction nodes and corresponding time-decayed weighted edges. The time-decayed line graph system can also generate predictions or classifications based on these temporal edge embeddings. To illustrate, in one or more implementations, the time-decayed line graph system utilizes a machine learning model to learn timed interactions between entities. For example, the time-decayed line graph system utilizes a machine learning model to generate a predicted edge classification based on temporal edge embeddings from the time-decayed weighted edges. Furthermore, in some implementations, the time-decayed line graph system utilizes a binary temporal link classification machine learning model to generate a binary temporal link prediction from temporal edge embeddings.

As mentioned, the disclosed time-decayed line graph system can provide a variety of advantages and benefits over conventional systems and methods. For example, given that timestamps are associated with edges rather than nodes, constructing a time-decayed line graph that derives node embeddings directly from edge embeddings provides a line graph that directly represents topological and temporal proximity. Practically, the time-decayed line graph system provides a system that is simple to implement, yet is accurate and efficient, and can provide superior predictive and runtime performance relative to prior methods.

For instance, in one or more embodiments the disclosed time-decayed line graph system significantly improves the efficiency of utilizing temporal graph networks by reducing system overhead. As mentioned, many existing deep learning methods require first creating node embeddings, then aggregating them (e.g., by taking the entrywise product of two endpoint nodes' embeddings). In contrast, the disclosed time-decayed line graph system can directly form embeddings for continuous-time temporal edges without supervision and without aggregating node embeddings. Unlike prior methods, in one or more implementations the time-decayed line graph system works directly with continuous timestamps rather than requiring discretization of times, and directly generates temporal edge embeddings rather than requiring aggregation of node embeddings thereby reducing system overhead. Indeed, in contrast to prior methods, the time-decayed line graph system can create a sparse matrix of proximities between temporal edges which provides a high ease of implementation. Due in part to this approach, the time-decayed line graph system achieves superior performance on predictive and downstream tasks while requiring less runtime.

With regard to flexibility, the time-decayed line graph system can be effective even when returning the direct encoding of the time-decayed line graph as embeddings (e.g., a lazy compute). In other words, the time-decayed line graph system does not require an expensive dimensionality reduction procedure, which can reduce time efficiency. Alternatively, the time-decayed line graph system can employ a dimensionality reduction procedure to provide dense vector embeddings for downstream tasks and still provide more accurate results than conventional systems.

Additionally, in one or more embodiments the time-decayed line graph system is more accurate than prior systems. As mentioned, many conventional systems assume time to be discretized. Thus, although time data is naturally represented as a continuous stream of timestamped edges, prior systems must determine the discretization and discard precise time information. Such discrete-time representations are necessarily lossy approximations of the actual sequence of edges. Furthermore, in some conventional systems, edge representations are only calculated indirectly from the nodes, which is suboptimal for tasks like edge classification and link prediction. In contrast, the time-decayed line graph system can construct a line graph of the network, which includes a node for each interaction, and weights the edges of this graph based on the difference in time between interactions. This approach can lead to more accurate data representations. In sum, in one or more implementations the time-decayed line graph system more accurately works directly with continuous timestamps rather than requiring discretization of times, and directly generates temporal edge embeddings rather than requiring aggregation of node embeddings. As demonstrated in greater detail below, empirical results on real-world networks demonstrate improved efficacy of the time-decayed line graph system on both edge classification and temporal link prediction in accordance with one or more embodiments.

As illustrated by the foregoing discussion, the present disclosure utilizes a variety of terms to describe features and advantages of the time-decayed line graph system. Additional detail is now provided regarding the meaning of such terms. For example, as used herein, the term “temporal graph network” refers to a graph representation of interconnected nodes that include a representation of time. In particular, a temporal graph network is composed of nodes and edges that represent entities or relationships, and the edges that have a temporal property associated with them. For example, temporal property can represent when, how long, or how often an incident occurs. Temporal graph networks are useful for analysis of dynamic data, such as social networks, stock markets, or transportation networks. They can be used to track changes over time and identify patterns or correlations between different nodes or edges. The temporal graph network is a dynamic structure which changes over time as new edges are added or existing edges are removed. For instance, temporal graph networks can be used to detect fraud in financial transactions, patterns in web browsing, or to identify relationships between people in a social network.

Moreover, as used herein, the term “entity node” refers to a node in a temporal graph network that represents an entity (e.g., a person, place, object, or business). Accordingly, an entity node includes a node in a network which is connected to other nodes in the network. Thus, each entity node in the network represents an object or entity which interacts with other objects or entities.

Relatedly, as used herein, the term “temporal interaction edge” refers to a link, connection, or interaction between two entity nodes. In particular, entity nodes are connected to other nodes in the temporal graph network through temporal interaction edges which represent the temporal relationship (e.g., a continuous time representation of the relationship) and/or the temporal interaction between the two entity nodes. Indeed, in some implementations a temporal interaction edge is associated with a continuous time, where the time value is defined at every point (instead of statically defined with a finite set of discrete points in time). For instance, interaction edges can represent the duration of entity interactions over time. For example, a temporal interaction edge between two people in a social network may represent an interaction (e.g., a “like” at a particular time) between client devices of the friends.

Also, as used herein, the term “time-decayed line graph” refers to a line graph derived from a temporal graph network. In particular, a time-decayed line graph includes a graph representation of nodes and edges derived from a temporal graph network where the edges are weighted (or decayed) according to interaction times. Thus, in one or more embodiments the time-decayed line graph incorporates both the topological proximity in the original temporal graph network as well as the proximity in time. Indeed, in one or more embodiments the time-decayed line graph system constructs the time-decayed line graph from a temporal graph network by converting each edge (timed interaction) of the original temporal graph network into an interaction node and connecting interactions that share an endpoint node in the original temporal graph network using time-decayed weighted edges.

Moreover, as used herein the term “interaction node” refers to a node of a time-decayed line graph. In particular, in one or more implementations the interaction nodes are generated from the temporal interaction edges of the temporal graph network. For example, the time-decayed line graph system converts each temporal interaction edge (timed interaction) of the temporal network into an interaction node. Relatedly, as used herein, the term “time-decayed weighted edge” refers to edges in the time-decayed line graph that connect the interaction nodes. In particular, in one or more implementations, the time-decayed line graph system connects interaction nodes that share an endpoint entity node using a time-decayed weighted edge. Notably, in one or more embodiments, the edge weights in the time-decayed line graph are based on differences in time between interactions in the original temporal graph network. For example, the time-decayed weighted edges incorporate the time information from the temporal graph network, with interactions that occur closer together in time in the temporal graph network being connected with higher weights (e.g., time-decayed weight) in the time-decayed line graph.

As used herein, the term “temporal edge embedding,” (or “continuous-time edge embedding”) refers to an embedding or numerical representation derived from graph edges (i.e., graph edges reflecting continuous interaction times). A temporal edge embedding can include a vector representation for each time-decayed weighted edge (e.g., that can be provided to a classifier). In particular, given training data comprising a set of temporal edges and the class labels of some fraction of these edges, a time-decayed line graph matrix can be created using all of the edges. Indeed, a logistic regression classifier can be trained using the edges for which the classes are known and the corresponding rows of the matrix as feature vectors. For example, for temporal edge i, the time-decayed line graph system can return the ith row of a time-decayed line graph adjacency matrix (e.g., an m-dimensional sparse vector) as the temporal edge embedding or feature vector.

Relatedly, as used herein, the term “continuous-time node embedding,” (or “node embeddings”) refers to an embedding or numerical representation of graph nodes (e.g., nodes embeddings generated from continuous times reflected in the time-decayed line graph). In particular, in some implementations node embeddings are an aggregation of the continuous-time edge embeddings into continuous-time node embeddings that are used to recover node communities within the time-decayed line graph. For example, in some implementations, node embeddings are constructed from continuous-time edge embeddings by returning the mean of the continuous-time edge embeddings of all edges incident on that node.

Further, as used herein, the term “continuous-time” refers to a temporal representation in which events are recorded as points in a continuous time domain. This contrasts with a discrete time representation, in which events are recorded at particular time intervals and/or grouped into discrete time buckets. In a continuous-time representation, events are recorded as timestamps indicating the precise time (or near precise time, such as within one second or one minute) at which they occurred. Continuous-time representations allows for a more fine-grained representation of temporal dynamics, as events can be recorded at any point in time. For example, in a social network, continuous time might be used to record the time at which a user interacts with another user (as opposed to a discrete time representation that divides the week into 24-hour periods and record the number of interactions made by each person during each period). This could include actions such as sending a message, commenting on a post, or liking a photo.

Relatedly, as used herein, the term “entity interactions” refers to a person, object, or thing having an interaction, contact, or relationship with another person, object, or thing. For example, an entity interaction indicates how entities (nodes or vertices) interact with each other over time through edges (links or relationships) that represent various types of relationships between entities. In particular, entities in temporal networks can have different attributes or properties, such as demographic information, geographic location, or functional roles. By representing each entity as a node in the graph, the time-decayed line graph system can define these attributes as node features, which can be used to characterize the entities and their relationships. For example, entity interactions can represent social interactions between devices on a social media platform using a dynamic network representation. In this case, the nodes would represent the client devices/users, and the edges would represent various types of interactions, such as purchases, clicks, likes, comments, shares, or follows. The edges can represent when the interaction occurred in continuous-time.

Additionally, as used herein “interaction time” (or “continuous interaction time”) refers to the time at which an interaction between two nodes occurs. For example, a temporal line network includes a type of temporal network where nodes are connected by edges that have a duration and a specific start and end time. For example, consider a social network where users can send messages to each other. Representing the network as a temporal line network, each message would be an edge with a start and end time that defines when the message was sent. The interaction time for each message would be the point on the timeline that corresponds to the time the message was sent.

Moreover, as used herein “predicted edge classification” refers to a label, category, or class of an edge (e.g., based on the patterns of interaction between nodes in the network). In particular, a predicted edge classification refers a label for a relationship between nodes (e.g., for future interactions). The time-decayed line graph system can generate a predicted edge classification by determining the type of interaction that is likely to occur between two nodes at a future time point, based on the historical interactions observed in the network over time. For example, the time-decayed line graph system can generate a predicted edge classification using a classification machine learning model trained on a set of vector representations and ground truth labels.

Moreover, as used herein “temporal link prediction” refers to a prediction of a relationship or link between nodes in a network (e.g., at a future time point, based on the historical interactions and patterns observed in the network over time). In particular, a temporal link prediction that includes a probability or likelihood of a link forming between two nodes in the future. For instance, a temporal link prediction can include a binary classification (e.g., where the goal is to predict whether a link will form between two nodes in the future, based on their past interactions).

In one or more embodiments, a time-decayed line graph system includes a machine learning model. As used herein, the term “machine learning model” refers to a computer algorithm or a collection of computer algorithms that can be trained and/or tuned based on inputs to approximate unknown functions. For instance, a machine learning model can include a computer algorithm with branches, weights, or parameters that change based on training data to improve for a particular task. Thus, a machine learning model can utilize one or more learning techniques to improve in accuracy and/or effectiveness. Example machine learning models include various types of decision trees, logistic regression, support vector machines, Bayesian networks, random forest models, or neural networks (e.g., deep neural networks). For instance, the time-decayed line graph system can utilize a convolutional neural network or a recurrent neural network to train a classifier given training data comprising a set of temporal edges and class labels.

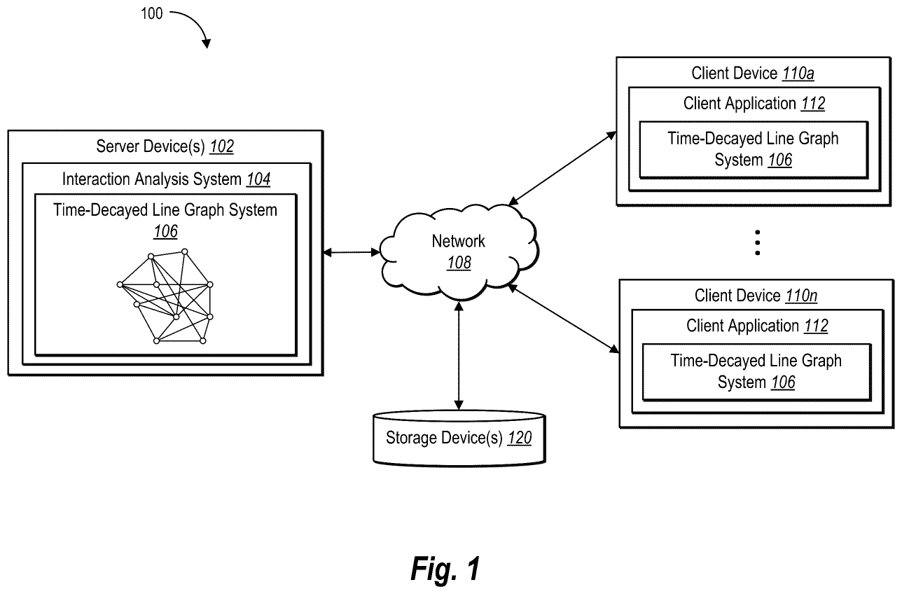

Additional detail regarding the object representation system will now be provided with reference to the figures. For example, FIG. 1 illustrates a schematic diagram of an exemplary system environment (“environment”) 100 in which a time-decayed line graph system 106 operates. As illustrated in FIG. 1, the environment 100 includes server device(s) 102, a network 108, storage device(s) 120, and client devices 110a-110n.

Although the environment 100 of FIG. 1 is depicted as having a particular number of components, the environment 100 is capable of having any number of additional or alternative components (e.g., any number of servers, client devices, or other components in communication with the time-decayed line graph system 106 via the network 108). Similarly, although FIG. 1 illustrates a particular arrangement of the server devices(s) 102, the network 108, storage device(s) 120, and the client devices 110a-110n, various additional arrangements are possible.

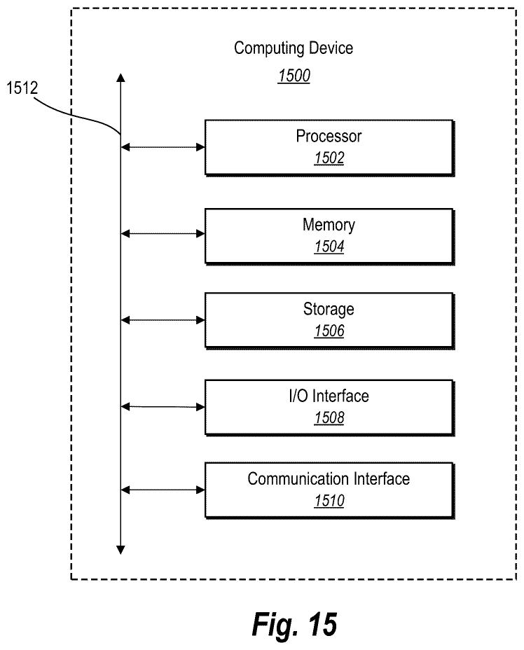

The server devices(s) 102, the network 108, storage device(s) 120, and the client devices 110a-110n are communicatively coupled with each other either directly or indirectly (e.g., through the network 108 discussed in greater detail below in relation to FIG. 15). Moreover, the server devices(s) 102 and the client devices 110a-110n include one of a variety of computing devices (including one or more computing devices as discussed in greater detail with relation to FIG. 15).

As illustrated in FIG. 1, the environment 100 includes the server device(s) 102. The server device(s) 102 generates, tracks, stores, processes, receives, and transmits electronic data, including neural networks, temporal graph networks, and time-decayed line graphs. For example, the server device(s) 102 receives or monitors interactions across the client devices 110a-110n. In some implementations, the server device(s) 102 transmit content to the client devices 110a-110n. For example, the server device(s) 102 can utilize a time-decayed line graph to predict a classification or temporal link corresponding to the client devices 110a-110n and generate content based on the prediction (e.g., provide a digital notification or recommendation for display via a user interface of the client devices 110a).

In some embodiments, the server device(s) 102 communicates with the client devices 110a-110n to transmit and/or receive content via the network 108. In some embodiments, the server device(s) 102 comprises a distributed server where the server device(s) 102 includes a number of server devices distributed across the network 108 and located in different physical locations. The server device(s) 102 can comprise a content server, an application server, a communication server, a web-hosting server, a multidimensional server, or a machine learning server. The server device(s) 102 can further access and utilize the storage device(s) 120 to store and retrieve information including information related to temporal graph networks and/or time-decayed line graphs.

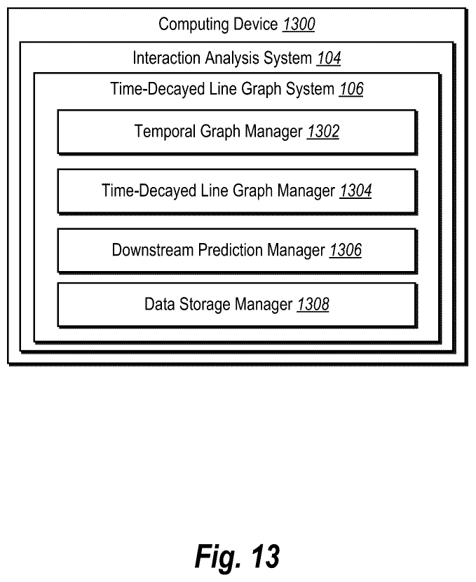

Additionally, the server devices(s) 102 includes all, or a portion of, the time-decayed line graph system 106. For example, the time-decayed line graph system 106 operates on the server device(s) 102 to identify temporal graph networks and/or time-decayed line graphs, determine editorial changes, and provide localization of editorial changes to the client devices 110a-110n. In one or more embodiments, via the server devices(s) 102, the time-decayed line graph system 106 generates time-decayed line graphs from temporal graph networks. Example components of the time-decayed line graph system 106 will be described below with regard to FIG. 13.

Furthermore, as shown in FIG. 1, the illustrated system includes the client devices 110a-110n. In some embodiments, the client devices 110a-110n include, but are not limited to, mobile devices (e.g., smartphones, tablets), laptop computers, desktop computers, or any other type of computing devices, including those explained below in reference to FIG. 15. Some embodiments of client devices 110a-110n are operated by a user to perform a variety of functions via respective client applications 112a-112n. The client devices 110a-110n include one or more applications (e.g., the client application 112) that can access, edit, modify, store, and/or provide, for display, temporal graph networks and/or time-decayed line graphs. For example, in some embodiments, the client applications 112a-112n include a software application installed on the client devices 110a-110n. In other cases, however, the client applications 112a-112n include a web browser or other application that accesses a software application hosted on the server(s) 102.

The time-decayed line graph system 106 can be implemented in whole, or in part, by the individual elements of the environment 100. Indeed, as shown in FIG. 1 the time-decayed line graph system 106 can be implemented with regard to the server devices(s) 102 and/or at the client devices 110a-110n. In particular embodiments, the time-decayed line graph system 106 on the client devices 110a-110n comprises a web application, a native application installed on the client devices 110a-110n (e.g., a mobile application, a desktop application, a plug-in application, etc.), or a cloud-based application where part of the functionality is performed by the server(s) 102.

In additional or alternative embodiments, the time-decayed line graph system 106 on the client devices 110a-110n represents and/or provides the same or similar functionality as described herein in connection with the time-decayed line graph system 106 on the server(s) 102. In some implementations, the time-decayed line graph system 106 on the server(s) 102 supports the time-decayed line graph system 106 on the client devices 110a-110n.

For example, in some embodiments, the server(s) 102 generate graphs and/or train one or more machine learning models described herein (e.g., classification machine learning model, a binary temporal link classification machine learning model, and/or a neural network). The time-decayed line graph system 106 on the server(s) 102 provides the graphs and/or the one or more trained machine learning models to the time-decayed line graph system 106 on the client devices 110a-110n for implementation. Accordingly, although not illustrated, in one or more embodiments the client devices 110a-110n utilize the one or more trained machine learning models to generate temporal graph networks and/or time-decayed line graphs. In some implementations, the server device(s) 102 build graphs and/or train machine learning models and also implement the graphs and/or machine learning models.

In some embodiments, the time-decayed line graph system 106 includes a web hosting application that allows the client devices 110a-110n to interact with content and services hosted on the server device(s) 102. To illustrate, in one or more implementations, the client devices 110a-110n accesses a web page or computing application supported by the server(s) 102. The client devices 110a-110n provides input to the server device(s) 102 (e.g., entity relationships). In response, the time-decayed line graph system 106 on the server device(s) 102 utilizes the trained machine learning models to generate a temporal graph network and/or a time-decayed line graph. The server(s) 102 then provides the temporal network and/or time-decayed line graph to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server device(s) 102, bypassing the network 108. As another example, the environment 100 includes a third-party server comprising a content server and/or a data collection server.

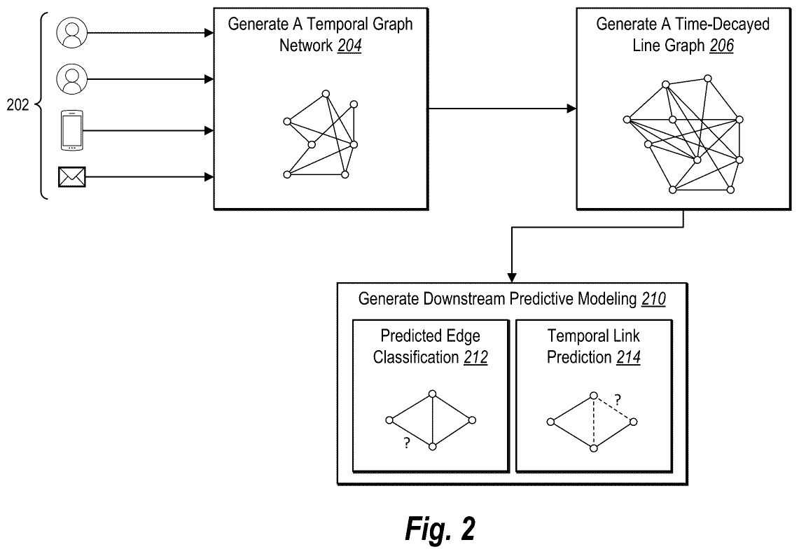

As previously mentioned, in one or more embodiments, the time-decayed line graph system 106 performs predictive modeling by building a time-decayed line graph from a temporal graph network. For instance, FIG. 2 illustrates an overview diagram of the time-decayed line graph system 106 performing predictive modeling utilizing a time-decayed line graph in accordance with one or more embodiments.

As shown in FIG. 2, the time-decayed line graph system 106 receives the temporal graph inputs 202 (e.g., entity interactions). As shown, the temporal graph inputs 202 comprise representations of entities, relationships between entities, and timestamps. In one or more embodiments, the time-decayed line graph system 106 determines the temporal graph inputs 202 by monitoring client device interactions. For example, the time-decayed line graph system 106 can monitor client device visits to websites, transmission of signals across client devices, or other digital interactions to determine the temporal graph inputs 202.

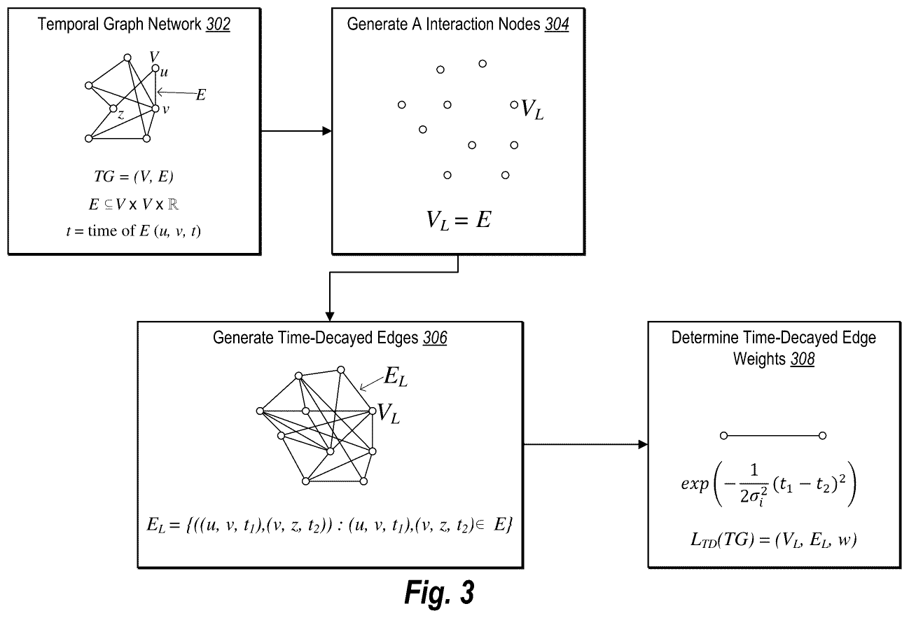

As illustrated, the time-decayed line graph system 106 performs the act 204 to generate a temporal graph network from the temporal graph inputs 202. Indeed, the temporal graph network generates a set of entity nodes that represent entities from the temporal graph inputs 202. The temporal graph network generates a set of temporal interaction edges that represent relationships/interactions between entities from the temporal graph inputs 202. Furthermore, the temporal graph network generates or identifies a set of timestamps to add temporal information to the graph that reflects the relationships/interactions over time from the temporal graph inputs 202. Additional detail regarding the temporal graph networks is provided below (e.g., in relation to FIG. 3).

Further, as shown in FIG. 2, the time-decayed line graph system 106 performs the act 206 to generate a time-delayed line graph. Indeed, the time-decayed line graph system 106 creates a line graph from the temporal graph network by deriving interaction nodes from temporal interaction edges of the temporal graph network and connecting interaction nodes that share an endpoint node in the temporal graph network (e.g., with time-decayed weighted edges). Then, the time-decayed line graph system 106 sets the edge weights in the time-decayed line graph based on differences in time between interactions, with interactions that occur closer together in time being connected with higher weights. Additional detail regarding the time-decayed line graph system 106 generating a time-decayed line graph is provided below (e.g., in relation to FIG. 3).

As further shown in FIG. 2, the time-decayed line graph system 106 performs the act 210 to generate downstream predictive modeling from the time-decayed line graph. In particular, the time-decayed line graph system 106 classifies the relationships between one or more nodes based on the features and attributes of the interaction nodes and time-decayed weighted edges (as well as other contextual information) to generate a predicted edge classification 212. In one or more implementations, the time-decayed line graph system 106 generates the predicted edge classification 212 utilizing a machine learning algorithm from a set of features and attributes of the interaction nodes and time-decayed weighted edges. For example, time-decayed line graph system 106 can utilize a machine learning model to generate the predicted edge classification 212 utilizing interaction node properties, time-decayed weighted edge weights, and/or interaction node proximity.

In one or more implementations, the time-decayed line graph system 106 trains a machine learning model on a labeled set of data to learn the relationships between the input features and the target labels. Once trained, the machine learning model can be used to make predictions on new, unlabeled time-decayed weighted edges, assigning time-decayed weights to each edge label based on the learned relationships. The time-decayed line graph system 106 can use the predicted edge classification 212 to gain insight into the relationships between interaction nodes in the graph and to make informed decisions based on those relationships. This information can be used for a variety of purposes, such as community detection, recommendation systems, and fraud detection. In addition, the time-decayed line graph system 106 generates a temporal link prediction 214 that reflects the likelihood of new links forming between nodes. In particular, the time-decayed line graph system 106 generates temporal link predictions from interaction nodes in the time-decayed line graph based on the temporal aspect of the graph (e.g., using historical evolution of the graph or past trends).

There are several methods that can be used for temporal link prediction and temporal link classification, including: statistical methods (e.g., Pearson correlation, mutual information, and cosine similarity), machine learning methods (e.g., machine learning algorithms such as decision trees, random forests, deep neural networks, and support vector machines), and temporal embedding methods (e.g., using temporal embeddings to represent nodes and edges in a low-dimensional space). For example, the time-decayed line graph system can generate a temporal link classification using a temporal link classification machine learning model trained on vector representations of historical time-decayed weighted edges. For example, the time-decayed line graph system can generate a temporal link prediction using a binary temporal link classification machine learning model trained on positive vector representations and negative vector representations of historical time-decayed weighted edges.

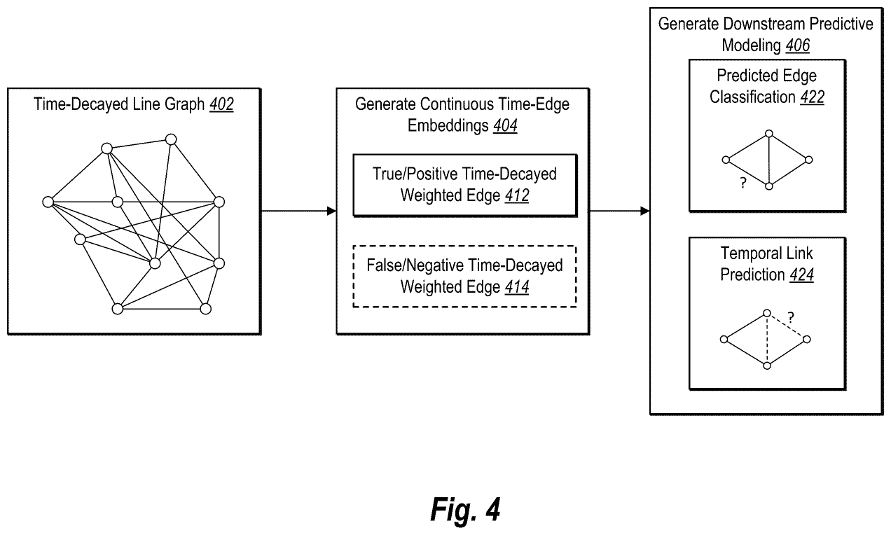

To illustrate, the time-decayed line graph system 106 can train a machine learning model on historical data to generate the temporal link prediction 214. For example, the time-decayed line graph system 106 can train a machine learning model from the time-decayed line graph to generate temporal link predictions that represent the future state of the network. The models can be trained using various features of the interaction nodes and time-decayed weighted edges, such as interaction node attributes, time-decayed weighted edge weights, and/or interaction node proximity. The temporal link predictions 214 represent the most likely future relationships and can be utilized by the time-decayed line graph system 106 to generate notifications/recommendations or initiate other downstream processes. Additional detail regarding generating the time-decayed line graph system 106 generating various predictions is provided below (e.g., in relation to FIG. 4).

As mentioned, the temporal link classification 212 and temporal link prediction 214 can be used for a variety of purposes, such as recommendation of temporally relevant web pages, segments, products of interest, recommending temporally relevant data attributes a data analysis platform, temporally relevant insight recommendation in a data analytics platform, community detection, recommendation systems, or fraud detection. For example, by analyzing user data, such as browsing history or purchase behavior, systems can identify different segments (groups of users who share similar characteristics or behavior) and provide personalized messaging and offers. In particular, the time-decayed line graph system 106 can further refine these segments by analyzing temporal link classifications 212 and temporal link predictions 214 to evaluate segment behavior over time (e.g., identify users who are consistently interested in a particular product category or who exhibit seasonal buying patterns) and can increase the likelihood of engagement and conversion.

As another example, the time-decayed line graph system 106 can be used to recommend temporally relevant web pages to client devices (e.g., web pages that are timely and relevant to current interests or needs) by analyzing temporal link classifications 212 and temporal link predictions 214 to identify/predict patterns and trends. To illustrate, during the holiday season, a client device searching for gift ideas might be more interested in web pages featuring gift guides and product recommendations than in pages featuring general product information. By recommending web pages that are timely and relevant to a client device, the time-decayed line graph system 106 can improve the accuracy of generated notifications and reduce wasted resources in sending unnecessary digital content.

As another example, the time-decayed line graph system 106 can be used to identify products or items to client devices over time by analyzing previous client device interactions. To illustrate, the time-decayed line graph system 106 can monitor a client device used to regularly purchases fitness products and gym memberships to determine an affinity toward recommendations for new workout equipment or health supplements. Through use of temporal link classifications 212 and temporal link predictions 214, the time-decayed line graph system 106 can identify this as a segment and recommend products to the client device.

Similarly, the time-decayed line graph system 106 can recommend temporally relevant analytics by identifying patterns and trends over time. For example, the time-decayed line graph system 106 can use temporal link classifications 212 and temporal link predictions 214 to track relevant data attributes within a data analytics system. For example, the time-decayed line graph system 106 can manage millions of data attributes and select those data attributes that are most likely to be relevant to a particular client device/user in analyzing pertinent data repositories. Indeed, the time-decayed line graph system 106 can provide analytics that are timely and relevant, to enable the time-decayed line graph system 106 to identify anomalies or outliers in data.

As previously mentioned, in one or more embodiments, the time-decayed line graph system 106 determines time-delayed edge weights from a temporal graph network. For example, FIG. 3 illustrates a time-decayed line graph system 106 generating interaction nodes, time-delayed edges, and weights for the time-delayed edges from a temporal graph network.

Indeed, in one or more implementations, the time-decayed line graph system 106 generates time-decayed line graphs by deriving them from temporal graph networks. In particular, the time-decayed line graph system 106 extends conventional line graphs, which are derived from static (e.g., non-temporal), undirected graphs by incorporating time information to create time-decayed line graphs. In this way, rather than an generating an undirected, unweighted graph that simply represents adjacencies between edges in the original graph, the time-decayed line graph system 106 incorporates time information by using it to set the weights of the time-decayed line graph.

In particular, as illustrated in FIG. 3, the time-decayed line graph system 106 obtains a temporal graph network TG (illustrated by act 302) and generates time-decayed weighted edges from the time-decayed line graph. Specifically, the temporal graph network TG is composed of entity nodes (represented by vertices V in FIG. 3) and temporal interaction edges (connections/relationships between the vertices represented by E in FIG. 3). Each temporal interaction edge is associated with a start time, end time, and/or continuous-time interval (time domain t in FIG. 3) which is associated with when the interaction or relationship between the vertices occurs. As shown, the temporal interaction edge set is denoted by E.

Furthermore, the time-decayed line graph system 106 generates the temporal interaction nodes and time-decayed weighted edges from the continuous times corresponding to the temporal interaction edges. In particular, the time-decayed line graph system 106 generates interaction nodes (illustrated by act 304) from temporal interaction edges of the temporal graph network. Indeed, to construct the time-decayed line graph, the time-decayed line graph system 106 converts each of the temporal interaction edges into an interaction node.

Indeed, for a given temporal graph network, the time-decayed line graph system 106 can generate multiple interaction nodes. For example, the time-decayed line graph system 106 can generate a first interaction node from a first temporal interaction edge of the temporal graph network that corresponds to a first continuous interaction time; generate a second interaction node from a second temporal interaction edge of the temporal graph network that corresponds to a second continuous interaction time, generate a third interaction node from a third temporal interaction edge of the temporal graph network that corresponds to a third continuous interaction time, and generate a fourth interaction node from a second temporal interaction edge of the temporal graph network that corresponds to a fourth continuous interaction time. Indeed, the time-decayed line graph system 106 can generate a number of interaction nodes that corresponds to the number of temporal interaction edges of the temporal graph network and correspond to the associated continuous interaction time of the temporal interaction edges.

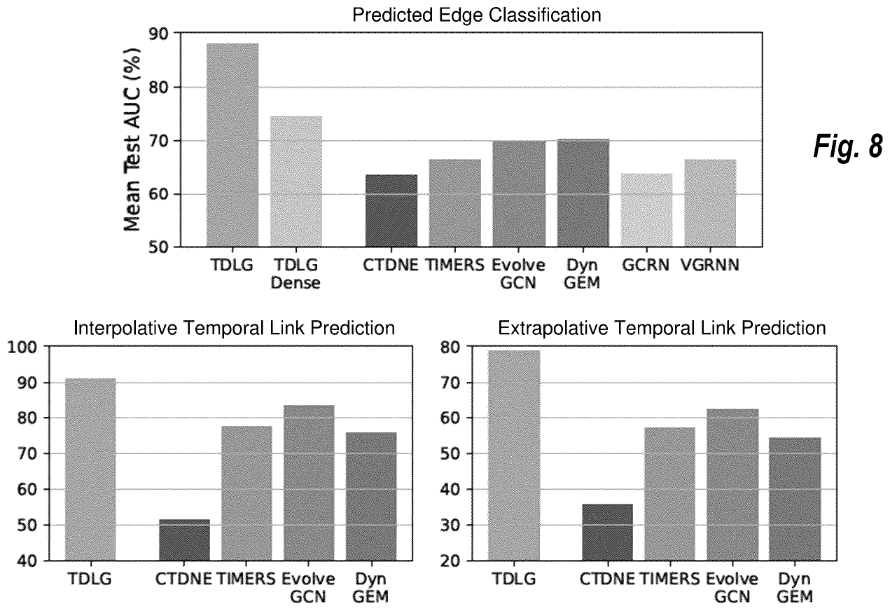

Similarly, for a given temporal graph network, the time-decayed line graph system 106 can generate multiple time-decayed weighted edges. In particular, the time-decayed line graph system 106 generates time-decayed edges (illustrated by act 306) between interaction nodes based on determining that interaction edges are connected to the same shared entity node of the temporal graph network. For example, the time-decayed line graph system 106 can generate a first time-decayed weighted edge between the first interaction node and second interaction node based on determining that the first temporal interaction edge and the second temporal interaction edge are connected to a shared entity node of the temporal graph network (as described above). Furthermore, the time-decayed line graph system 106 can generate a second time-decayed weighted edge between the first interaction node and third interaction node based on determining that the first temporal interaction edge and the third temporal interaction edge are connected to a shared entity node of the temporal graph network. In a similar fashion, the time-decayed line graph system 106 can generate additional time-decayed weighted edges (e.g., third time-decayed weighted edge, fourth time-decayed weighted edge). To illustrate, as shown in FIG. 8, edge E_{L} is a time-decayed edge of the time-decayed line graph that connects two interaction nodes generated from temporal edges (u, v, t₁) and (u, z, t₂) of the temporal graph that are connected to a common entity node u.

The time-decayed line graph system 106 captures the temporal dynamics of the entity node interactions and generates continuous-time edge embeddings for each time-decayed weighed edge to represent the time-decayed weighted edges as vectors in high-dimensional space. Indeed, the time-decayed line graph system 106 creates an informative real-valued vector for each edge. For example, the time-decayed line graph system 106 can generate a continuous-time edge embedding from the time-decayed weighted edge and a second continuous-time edge embedding from the second time-decayed weighted edge. One or more dimensions of the vector represent the temporal dynamics of the edge (e.g., the continuous time interval between interactions). Continuous-time edge embeddings can be used for a variety of tasks, such as link prediction, anomaly detection, and community detection in temporal networks. By capturing the temporal dynamics of time-decayed weighted edges, the time-decayed line graph system 106 provides insights into how relationships between interaction nodes change over time, which can be useful for understanding the behavior of complex systems such as social networks, financial networks, and biological networks.

Moreover, the time-decayed line graph system 106 determines the time-decayed edge weights, as illustrated by act 308, for the time-decayed weighted edges based on the differences in time between interactions in the temporal graph network. In particular, in one or more embodiments, the time-decayed line graph system 106 generates a time-decayed weighted edge between the first interaction node and the second interaction node (as described above) and determines a time-decayed weight for the time-decayed weighted edge based the difference between the first interaction time and the second interaction time. As mentioned, the first interaction time can be a first continuous interaction time and the second interaction time can be a second continuous interaction time. Thus, the time-decayed line graph system 106 can generate the time-decayed weighted edge based on representations in continuous time (e.g., first continuous time and the second continuous time). In particular, in one or more embodiments, the time-decayed weight for the time-decayed weighted edge is inversely proportional to the time difference (e.g., the time-decayed weight increases as the time difference decreases). To illustrate, the time-decayed line graph system 106 controls how quickly the proximity in the time-decayed line graph system decays as the difference in time grows (as shown by parameter σₜ in FIG. 3). Thus, as shown by FIG. 3, the edge weight incorporates both topological proximity in the original graph as well as proximity in time.

To elaborate, as illustrated in FIG. 3, the time-decayed line graph system 106 constructs a weighted line graph L_{TD}(TG) from a temporal graph network TG. In particular, the time-decayed line graph system 106 performs an act 302 to define a temporal graph network comprising a sequence of timestamped edges where the temporal graph network is represented as TG=(V, E), and comprises a set of vertices V and a set of temporal interaction edges E, where E⊆V×V× [symbol] , t is the time of the temporal interaction edge (u, v, t), and u and v are entity nodes. The time-decayed line graph system 106 performs an act 304 to generate interaction nodes from the set of temporal interaction edges where V_{L}=E. The time-decayed line graph system 106 performs the act 306 to generate time-delayed edges where the associated time-decayed line graph is given by L_{TD}(TG)=(V_{L}, E_{L}, w), and the time-delayed edges are given by E_{L}={((u, v, t₁), (u, z, t₂)): (u, v, t₁), (u, z, t₂)∈E}. The time-decayed line graph system 106 performs act 308 to determine time-decayed edge weights where the edge weight function w: E_{L}→ [symbol] ₊ is evaluated on edge ((u, v, t₁), (u, z, t₂)) and is given by exp

$$( - \frac{1}{2 {σ}_{t}^{2}} {( {t}_{1} - {t}_{2} )}^{2} )$$

for some fixed σₜ>0.

Thus, proximity of two temporal edges in the time-decayed line graph incorporates both topological proximity in the original graph as well as the proximity in time. The parameter σₜ controls how quickly proximity in the time-decayed line graph decays as difference in time grows. For a graph with n interaction nodes and m time-decayed weighted edges, the time-decayed line graph system 106 constructs the weighted adjacency matrix A∈ [symbol] ₊^{m×m} of the time-decayed line graph as follows. Given the incidence matrix B∈{0,1}^{n×m}, each column vector of which is n-dimensional, corresponds to a time-decayed weighted edge, and is 1 for the time-decayed weighted edge's two endpoint nodes and 0 elsewhere; and also given the vector of times of the time-decayed weighted edges t∈ [symbol] ^{m}:

$${A}_{ij} = ( {b}_{i}^{T} {b}_{j} ) \cdot exp ( - \frac{{( {t}_{i} - {t}_{j} )}^{2}}{2 {σ}_{t}^{2}} ) ,$$

where bᵢ and bⱼ denote columns i and j of B. Note that A can be symmetric (e.g., while self-loops in line graphs are generally removed, they can remain for simplicity). Notably, although as shown in FIG. 3 the time-decayed line graph system 106 utilizes a Gaussian weight decay (where the penalty term is proportional to the sum of the squared weights), the time-decayed line graph system 106 can utilize other weight decay methods (e.g., Laplacian decay, where weights decay exponentially with the absolute value of the time elapsed; or a periodic decay, where weights decay exponentially with the absolute value of the time elapsed, modulo some prespecified time period).

As mentioned above, the time-decayed line graph system 106 performs downstream predictive modeling based on a time-decayed line graph generated from the temporal graph network. FIG. 4 illustrates an overview of the time-decayed line graph system 106 generating downstream predictive modeling 406 for a time-decayed line graph in accordance with one or more embodiments.

The time-decayed line graph system 106 generates continuous-time edge embeddings as informative real-valued vector representations that can be provided to a classifier (e.g., classification machine learning model and/or binary temporal link classification machine learning model) for each time-decayed weighted edge. As shown in FIG. 4, the time-decayed line graph system 106 performs act 404 to generate continuous time-edge embeddings from the time-decayed line graph 402 for use in downstream predictive modeling tasks. In particular, in one or more embodiments, the time-decayed line graph system 106 uses a supervised learning pipeline to generate continuous time-edge embeddings for generating downstream predictive modeling tasks. The time-decayed line graph system 106 utilizes a model (e.g., a machine learning model) that is initialized with an initial set of weights and parameters.

Indeed, in one or more embodiments, the time-decayed line graph system 106 utilizes training data comprising a set of time-decayed weighted edges and the class labels of some fraction of the time-decayed weighted edges. Utilizing the training data, the model makes predictions about the class labels of the time-decayed weighted edges. After the model has made predictions, the difference between the predicted time-decayed weighted edges and class labels and the actual time-decayed weighted edges and class labels is calculated using a loss function. Once the loss has been calculated, the model's parameters are updated through backward propagation to reduce the loss function. Furthermore, the model performs multiple iterations with the training dataset until the model's parameters converge to a set of values that minimize the loss function. Moreover, during the training process, the model's performance is monitored on a separate validation dataset of time-decayed weighted edges and the class labels to ensure that it is not overfitting to the training data. The training process can also involve tuning the model's hyperparameters, such as the learning rate, batch size, and number of epochs.

In one or more embodiments, the classification machine learning model performs act 404 to generate continuous-time node embeddings for a time-decayed line graph with n nodes and m edges and time-decayed weighted edge i using the ith row of the time-decayed line graph adjacency matrix A. Indeed, the classification machine learning model uses an m-dimensional sparse vector as the feature vector. Notably, in one or more embodiments, the time-decayed line graph system 106 does not reduce the dimensionality of these vectors. However, in one or more embodiments, the time-decayed line graph system 106 reduces the dimensionality of these vectors to decompose the matrix into its eigenvalues and eigenvectors (e.g., via eigen decomposition) and create dense eigenvector embeddings (e.g., TDLG Dense).

As further shown in FIG. 4, the time-decayed line graph system 106 uses a supervised learning pipeline to generate a predicted edge classification 424. Indeed, the time-decayed line graph matrix A is created using the time-decayed weighted edges (e.g., true/positive time-decayed weighted edges 412), and a classification machine learning model (e.g., logistic regression classifier) is trained as described above using the time-decayed weighted edges for which the classes are known and the corresponding rows of A as feature vectors. Moreover, the classification machine learning model is trained on a set of vector representations and ground truth labels to make predicted edge classifications. For example, the classification machine learning model makes a prediction (e.g., a binary prediction) to estimate the probability that a predicted edge classification belongs to the positive class using a logistic function. In one or more embodiments, the classification machine learning model minimizes the loss function (e.g., using a binary cross-entropy loss function or gradient descent algorithm). For example, the classification machine learning model computes the loss (e.g., binary cross-entropy loss) for each training set of vector representations and ground truth labels. The classification machine learning model uses an optimization algorithm to adjust parameters in the direction that decreases the loss. The classification machine learning model repeats this process over multiple iterations (epochs) until reaching a stopping trigger (e.g., the loss is minimized to a threshold level or performing a threshold number of iterations). After this, the classification machine learning model is used on the remaining rows to determine predicted edge classifications for the remaining time-decayed weighted edges.

As also shown in FIG. 4, the time-decayed line graph system 106 uses a supervised learning pipeline to generate a temporal link prediction 424. In particular, the time-decayed line graph system 106 generates two different types of temporal link prediction: namely, interpolative temporal link prediction and extrapolative temporal link prediction.

The time-decayed line graph system 106 generates interpolative temporal link predictions by predicting edges between nodes that already exist in the graph. In particular, by identifying new edges between existing nodes based on the existing dense graph structure (rather than extrapolating or extending the existing patterns in the network), the time-decayed line graph system 106 can generate an interpolative temporal link prediction. Indeed, the time-decayed line graph system 106 can generate an interpolative temporal link prediction using a variety of techniques, such as matrix factorization, graph embedding, and neural network models. to capture the inherent structure of the network and use it to predict potential new links. For example, the time-decayed line graph system 106 can use matrix factorization techniques to factorize the adjacency matrix of a network into low-dimensional representations of nodes and use the node representations to predict new links. As another example, the time-decayed line graph system 106 can use graph embedding techniques to learn low-dimensional representations of nodes and edges in a network and use these representations to make predictions about new links.

Furthermore, the time-decayed line graph system 106 generates extrapolative temporal link predictions by predicting edges between nodes that do not currently exist in the graph. The time-decayed line graph system 106 extrapolates to extend the patterns in the current network and infer the likelihood of new links forming in the future to generate extrapolative temporal link predictions. For example, if two individuals have been observed to frequently communicate or collaborate in the past, it is likely that they will continue to do so in the future. The time-decayed line graph system 106 generates an extrapolative temporal link prediction by employing statistical or machine learning methods to make predictions about new links that may form in the network. The time-decayed line graph system 106 can use methods such as analyzing the similarity between nodes, looking for common neighbors, or using matrix factorization techniques to generate an extrapolative temporal link prediction. The time-decayed line graph system 106 can use the extrapolative temporal link predictions for a variety of purposes, such as recommending new connections to users in a social network or predicting the spread of a disease through a network.

As mentioned above, the time-decayed line graph system 106 generates the temporal link prediction 424. The temporal link prediction 424 can include a predicted positive time-decayed weighted edge or a predicted negative time-decayed weighted edges. In particular, in one or more embodiments, the time-decayed line graph system 106 utilizes a binary temporal link classification machine learning model to classify pairs of input data as either related or unrelated based on the temporal order of the data (e.g., whether one piece of data came before or after another piece of data). The binary temporal link classification machine learning model is given a set of input data (e.g., training data) and learns how to classify the data based on patterns and relationships within the training data. In one or more embodiments, the training data used to train the model is composed of two types of input data: positive and negative (represented as vectors that capture the relationships between the different features of the data).

In particular, in one or more embodiments, the time-decayed line graph system 106 utilizes a binary temporal link classification machine learning model trained on positive vector representations (e.g., positive time-decayed weighted edges) and negative vector representations (e.g., negative time-decayed weighted edges) of historical time-decayed weighted edges to make a binary temporal link prediction. Positive vectors represent pairs of positive time-decayed weighted edges that are related in time, while negative vectors represent pairs of time-decayed weighted edges that are unrelated in time. Indeed, in one or more implementations, the binary temporal link classification machine learning model classifies pairs of input data as related or unrelated based on the temporal order of the data and is trained on a training data comprising a set of positive time-decayed weighted edges that includes both positive and negative pairs of vectors.

To illustrate, the binary temporal link classification machine learning model utilizes binary temporal edge classification where the classes are +1 for true/positive time-decayed weighted edges 412 (e.g., (uᵢ, vᵢ, tᵢ)) and −1 for false/negative time-decayed weighted edges 414 (e.g., (u′ᵢ, v′ᵢ, t′ᵢ)). For temporal link prediction, the time-decayed line graph system 106 forms representations for negative time-decayed weighted edges, as well as for test time-decayed weighted edges (which are not given when training the classification machine learning model to perform predicted edge classification 422).

For example, in one or more embodiments, the time-decayed line graph system 106 represents the training edges as r and the test edges as e. The time-decayed line graph system 106 treats the negative time-decayed weighted edges the same as positive time-decayed weighted edges (besides the class labels) and the positive time-decayed weighted and negative time-decayed weighted training edges are concatenated, to produce the training incidence matrix Bᵣ∈{0,1}^{n×m}^{ᵣ} and times vector tᵣ∈ [symbol] ^{m}^{ᵣ}, from which the time-decayed line graph system 106 constructs the training time-decayed line graph adjacency matrix Aᵣᵣ∈ [symbol] ^{m}^{ᵣ}^{×m}^{ᵣ} as outlined above in relation to equation

$${A}_{ij} = ( {b}_{i}^{T} {b}_{j} ) \cdot exp ( - \frac{{( {t}_{i} - {t}_{j} )}^{2}}{2 {σ}_{t}^{2}} ) ,$$

The binary temporal link classification machine learning model is then trained using the rows of Aᵣᵣ as feature vectors and the edge labels (i.e., true/positive time-decayed weighted edges and false/negative time-decayed weighted edges). The time-decayed line graph system 106 utilizes feature vectors for the test edges that are mᵣ-dimensional and consider only proximity to training edges. The time-decayed line graph system 106 sets the test incidence matrix to be Bₑ∈{0,1}^{n×m}^{ₑ}, the test times vector to be tₑ∈ [symbol] ^{m}^{ₑ}, and the test edge feature vectors to be the rows of the matrix Aₑᵣ∈ [symbol] ^{m}^{ₑ}^{×m}^{ᵣ}. The time-decayed line graph system 106 passes the (i, j)-th entry of the matrix Aₑᵣ, which is given by

$$( {b}_{ei} \cdot {b}_{rj} ) \cdot exp ( - \frac{{( {t}_{ei} - {t}_{rj} )}^{2}}{2 {σ}_{t}^{2}} ) ,$$

to the binary temporal link classification machine learning model for inference (e.g., for temporal link prediction).

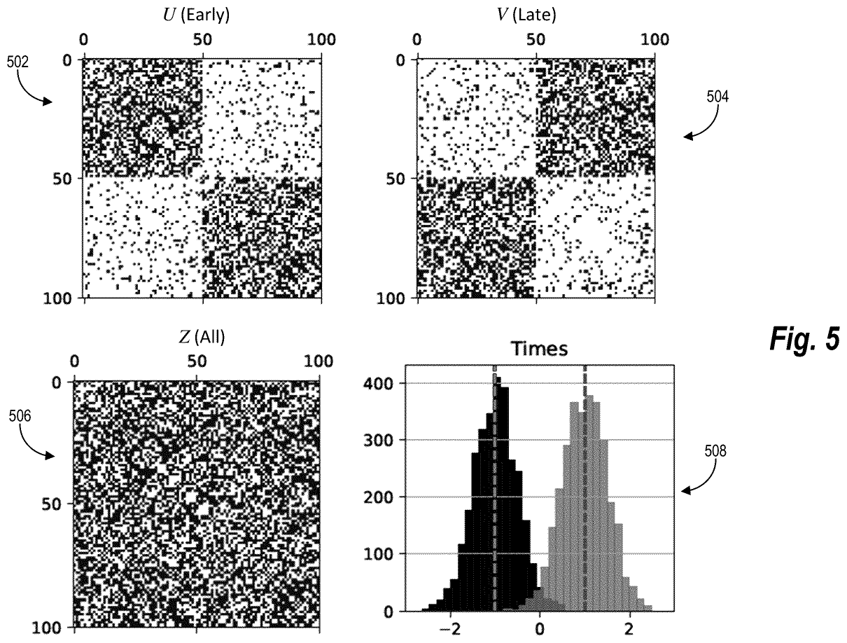

Indeed, the time-decayed line graph system 106 captures the underlying temporal patterns and relationships that exist between entities in temporal graph networks, although this latent temporal structure may not be immediately observable from raw data. FIG. 5 illustrates an example of an interaction node distribution where the time-decayed line graph system 106 captures the latent structure of a temporal graph network in accordance with one or more embodiments. For example, FIG. 5 illustrates a union of multiple temporal graph networks (e.g., temporal graph union Z) where each temporal graph network (e.g., U and V) is based on a stochastic block model (SBM) and a normal distribution is attached to each temporal graph network and the temporal interaction edges of each temporal graph network are associated with a time which is sampled from a normal distribution. In particular, a temporal graph union can be a union of Gaussian-timed stochastic block models (UGT-SBM) that naturally extends the stochastic block model (SBM) for static networks to temporal networks. For example, a temporal graph union can comprise the union of several stochastic block models, where a normal distribution is attached to each stochastic block model, and the edges drawn from a stochastic block model are given a time which is sampled from its distribution.

Particularly, FIG. 5 illustrates a temporal graph union Z where it is impossible to distinguish any community structure without utilizing temporal information. In particular, FIG. 5 illustrates a set of n entity nodes partitioned into two equal-sized communities U (image 502) and V (image 504). Indeed, the time-decayed line graph system 106 constructs a set of random temporal interaction edges over the temporal graph union Z as follows: for some integer Δ>0 and real numbers 0<α₁, a₂<1, let there be

$$\frac{Δ \cdot n}{2}$$

temporal interaction edges in each of two time periods; the times associated with temporal interaction edges in each time period are drawn from the normal distributions N(μ₁,σ₁²) and N(μ₂,σ₂²), respectively; of the temporal interaction edges in time period 1, let

$$( 1 - {α}_{1} ) \frac{Δ \cdot n}{2}$$

temporal interaction edges be drawn uniformly at random from U×V, and let the remaining

$${α}_{1} \frac{Δ n}{2}$$

temporal interaction edges be drawn half each from U×U and V×V. Similarly, of the temporal interaction edges in time period 2, let

$$( 1 - {α}_{2} ) \frac{Δ \cdot n}{2}$$

temporal interaction edges be drawn from U×V, and the remaining

$${α}_{2} \frac{Δ \cdot n}{2}$$

temporal interaction edges be drawn half each from U×U and V×V. Here A is the expected degree of each entity node in each of the two temporal graph networks (so the total degree of each entity node is 2·Δ), and α₁, α₂ represent the fraction of temporal interaction edges in each temporal graph network which are intra-community as opposed to inter-community. Notably, these requirements generalize straightforwardly to a union of an arbitrary number of temporal graph networks, potentially with unequal community sizes.

As further illustrated in FIG. 5, the time-decayed line graph system 106 constructs a union Z of the temporal graph networks from the temporal graph network U and the temporal graph network V where Z=U∪V. As shown in image 506, if temporal information is disregarded, it is difficult to distinguish any community structure in Z. Here, Z has n=100 entity nodes, with expected degrees Δ=40, and the time distributions from U and V are N(−1, (½)²) and N(+1, (½)²); the distributions have the same variance, but one occurs earlier on average. The time-decayed line graph system 106 sets α₁= 9/10 and α₂= 1/10, so that the mean fraction of intra-community temporal interaction edges is

$$\frac{{a}_{1} + {a}_{2}}{2} = 1 / 2 ;$$

this ensures that it is impossible to retrieve community structure without considering temporal information, as illustrated in image 506 (the union of U and V) which is an Erdös-Rényi graph (e.g., a graph that is a random combination of nodes connected by edges where the degree distribution, the number of edges connected to each node, follows a binomial distribution). In particular, as illustrated in image 508, the time-decayed line graph system 106 generates an adjacency matrix from Z of the early and late temporal interaction edges, where the distribution of times is separated in time by the early and late temporal interaction edges.

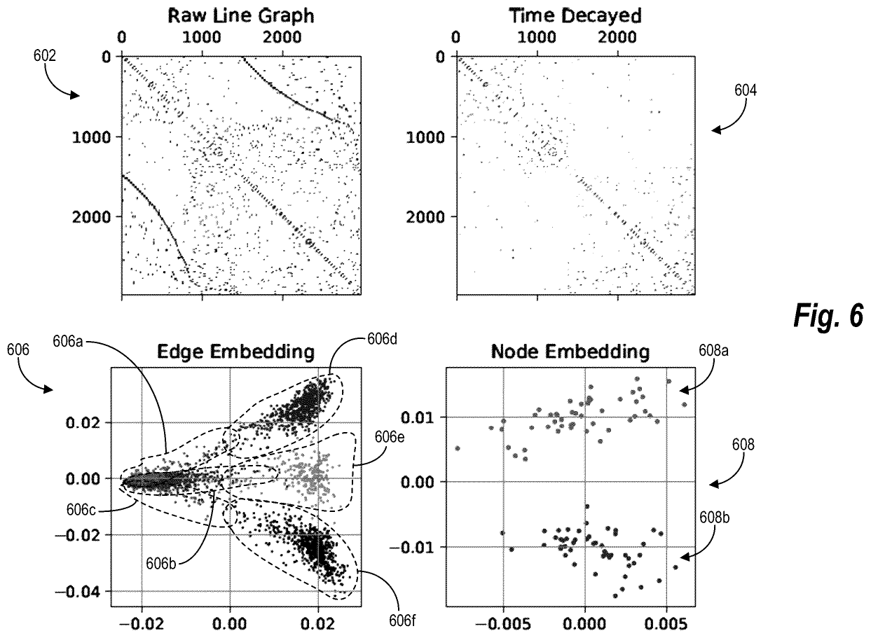

As mentioned, the time-decayed line graph system 106 can utilize the temporal information to recover the node communities of the time-decayed line graph. As illustrated in FIG. 6, in an exemplary implementation the time-decayed line graph system 106 provides accurate results when utilizing continuous-time edge embeddings to recover the node communities of the time-decayed line graph. Indeed, in contrast with deep methods, the complexity of which often precludes explicit analysis, the simplicity of the time-decayed line graph system 106 in one or more embodiments allows the time-decayed line graph system 106 to generate an exact (or nearly exact) expectation for the time-decayed line graph adjacency matrix A for the temporal graph networks as discussed above in relation to FIGS. 3-5.

To recover the node communities as shown in FIG. 6, the time-decayed line graph system 106 aggregates the continuous-time edge embeddings into continuous-time node embeddings. Indeed, the time-decayed line graph system 106 preserves and disentangles the node community structure of temporal graph networks: specifically, by taking the continuous-time edge embeddings returned by the time-decayed line graph system 106 and aggregating them into continuous-time node embeddings. In particular, the time-decayed line graph system 106 determines continuous-time node embeddings by combining an interaction node's incident time-decayed weighted edges to generate continuous-time node embeddings that distinguish between the two node communities (e.g., by averaging the continuous-time edge embeddings of all time-decayed weighted edges incident on the interaction node).

For example, to generate continuous-time node embeddings for a time-decayed line graph with n nodes and m edges, with incidence matrix B∈ [symbol] ^{n×m}, the time-decayed line graph system 106 defines \tilde{B} to be the matrix that results from dividing each row of B by its sum. Given a matrix of k-dimensional edge embeddings Y∈ [symbol] ^{m×k}, the time-decayed line graph system 106 produces a matrix of node embeddings X∈ [symbol] ^{n×k}, via the matrix product X=\tilde{B}Y. The result is represented in FIG. 6. The line graph is ordered so that the early edges appear first. The embedding plots show the top second and third eigenvectors (by eigenvalue magnitude) of the time-decayed line graph adjacency. Notably, the edge types are roughly separated in the edge embeddings, and node types are linearly separated in the node embeddings.

In particular, FIG. 6 illustrates the time-decayed line graph adjacency matrix 604 generated from the from the temporal graph network 602 with σₜ=½ (e.g., a temporal graph union as described above), the temporal edge embeddings 606 generated from the time-decayed line graph adjacency matrix 604, and continuous-time node embeddings 608 generated by the time-decayed line graph system 106 in the method as described above. Notably, in one or more embodiments, the time-decayed line graph system 106 uses the raw rows of the time-decayed line graph adjacency matrix as continuous-time edge embeddings (which produces sparse vectors). In the embodiment illustrated in FIG. 6, for visualization purposes, the time-decayed line graph system 106 uses dense eigenvector embeddings (e.g., TDLG dense) to generate the representations as further described below. The embedding visualizations show that the time-decayed line graph system 106 recovers the community structure: As shown, the continuous-time edge embeddings roughly separate the 6 kinds of edges as represented by sections 606a, 606b, 606c, 606d, 606e, and 606f (i.e., edges in U×U, V×V, and U×V occurring in each of the two time periods), and further, the continuous-time node embeddings linearly separate the two node communities U and V as represented by sections 608a and 608b.

As shown by the following analysis, the time-decayed line graph system 106 preserves and disentangles the node community structure of temporal graph networks by taking the continuous-time edge embeddings returned by the time-decayed line graph system 106 and aggregating them into continuous-time node embeddings. Notably, although the analysis below would be similar for one or more embodiments, the results shown in FIG. 6 are based on an embodiment where the time-decayed line graph system 106 analyzes the expected time-decayed line graph adjacency matrix and the expected incidence matrix with an assumed zero-time variance within time periods of the temporal graph network (which simplifies the analysis by reducing variance). Also, for the following analysis, the time-decayed line graph system 106 considers temporal graph networks in the limit as n→∞ for the simplicity of the resulting constant values.

Particularly, to determine the structure of time-decayed line graph adjacency matrix for a temporal graph union Z, the structure of Z is defined as follows. Define A∈ [symbol] ^{m×m} as the expected time-decayed line graph adjacency matrix of Z with node communities {U, V}, time periods {1, 2}, and zero-time variance (σ₁²=σ₂²=0). A has a 6×6 block structure where each block is constant-valued, that is, a multiple of an all-ones matrix J of some dimensionality. Letting subscripts denote time-period, the block matrix is indexed by 6 edge sets: (U×U)₁, (V×V)₁, (U×V)₁, (U×U)₂, (V×V)₂, and (U×V)₂. In the limit as n→∞, the constant values of each block are given by the Kronecker product

$$\begin{matrix}\begin{matrix}U \times U \\ V \times V \\ U \times V\end{matrix} & ( \begin{matrix}8 / n & 0 & 4 / n \\ 0 & 8 / n & 4 / n \\ 4 / n & 4 / n & 4 / n\end{matrix} )\end{matrix} ⊗ \begin{matrix}\begin{matrix}1 \\ 2\end{matrix} & ( \begin{matrix}1 & γ \\ γ & 1\end{matrix} )\end{matrix}$$

where

$$γ = exp ( - \frac{{( {μ}_{1} - {μ}_{2} )}^{2}}{2 {σ}_{t}^{2}} ) .$$

The sizes of the edge sets (and hence the sizes of the blocks) are

$${α}_{1} \cdot \frac{Δ \cdot n}{4} ,$$

$${α}_{1} \cdot \frac{Δ \cdot n}{4} ,$$

$$( 1 - {α}_{1} ) ,$$

$$\frac{Δ \cdot n}{2} ,$$

$${α}_{2} \cdot \frac{Δ \cdot n}{4} ,$$

$${α}_{2} \cdot \frac{Δ \cdot n}{4} ,$$

$$and$$

$$( 1 - {α}_{2} ) \cdot \frac{Δ \cdot n}{2} .$$

Note that writing A as a Kronecker product involves some abuse of notation, and the actual sizes of the edge sets are as given above in relation to FIG. 5.

As proof, to calculate an entry Aᵢⱼ of this matrix, consider the effect of the time decay, then the effect of edge adjacency (i.e., bᵢ^{T}bⱼ). Given the assumption of zero-time variance, there are only two possible values for each temporal edge's time, μ₁ and μ₂. This means effect of time decay on each entry of A is multiplication by either 1, if i and j occur at the same time, or otherwise γ. Second, calculate the expected value of bᵢ^{T}bⱼ, that is, the expected number of endpoint nodes shared between edges i and j. Suppose both i and j are in U×U. Since there are n/2 nodes in U, the probability of any two random nodes in U being the same is 2/n. There are 4 pairs of endpoints in U between i and j; in the assumed n→∞ limit, the 4 events of these pairs each having the same two nodes tend toward independence, so bᵢ·bⱼ=4·2/n=8/n. By similar logic, if i is in U×U and j is in U×V, there are 2 pairs of endpoints that could be identical (each of i's nodes in U with the single node of j in U), so bᵢ·bⱼ=2·2/n=4/n. The same holds if both i and j are in U×V. Finally, if i is in U×U and j is in V×V, there is zero chance of a shared endpoint. Remaining combinations follow by symmetry. Indeed, combining the terms for time decay and edge adjacency, the expected time-decayed line graph adjacency matrix has the specified 6×6 block structure.

Furthermore, as mentioned above, in one or more embodiments, the time-decayed line graph system 106 distinguishes among temporal graph union node communities utilizing continuous-time edge embeddings. To distinguish among temporal graph union node communities, the time-decayed line graph system 106 requires that it is not the case that α₁=α₂=½; since in the case of where both time periods are Erdös-Rényi and indistinguishable temporally, there is no community structure to recover. For example, the time-decayed line graph system 106 defines A∈ [symbol] ^{m×m} as the expected time-decayed line graph adjacency matrix of Z with node communities {U, V}, time periods {1, 2}, and zero-time variance (σ₁²=σ₂²=0). Define X∈ [symbol] ^{n×m} as the mean-edge node embeddings resulting from treating the rows of A as edge embeddings. Assuming γ≠1 and it is not the case that α₁=α₂=½, the node communities are distinguishable in X.

Indeed, this is proven as follows. As defined above, continuous-time node embeddings \tilde{X}∈ [symbol] ^{n×m} are given by the matrix product \tilde{X}=\tilde{B}A, where \tilde{B} results from dividing each row of the incidence matrix B∈ [symbol] ^{n×m} by its sum. Since the expected graph A is (2Δ), \tilde{X}=(1/(2Δ)) BA. For simplicity in this discussion, take X=BA; note that X are “sum-edge node embeddings,” which result from summing each of the edge embeddings of each node's incident edge rather than taking the mean. Considering the sum-edge node embeddings of two nodes, u=U and v∈V, let U′=U \{u} and V′=V \{v}, to calculate entries of the embeddings corresponding to U′×U′, V′×V′, and U′×V′ for the two time periods. The analysis below shows that the two nodes' embeddings are distinct under the assumptions on ∝₁, ∝₂ and γ.

In particular, starting with the expectation of node u's embedding xᵤ, which is a single row of X given by bᵤA, and where bᵤ is the incidence vector of node u. Hence, xᵤ is a sum of rows of A corresponding to edges which are incident on node u. Consider the row vector of A corresponding to such an edge u-w between distinct nodes u and w: in particular, by the assumption of zero time variance, the nonzero entries are 1 if the incident edges are in the same time period, otherwise γ. These incident edges are of the form w-z or u-z for some node z. Ignoring entries of the embedding vectors corresponding to columns of the latter type (due to only considering columns involving edges between U′, V′ rather than U, V), the expectation of entries of xᵤ can be calculated by counting the contributions of paths of length 2 of the form u-w-z with u≠w, z.

First, consider the (U′×U′)₁ block of xᵤ. Contributions to this block must come from paths of the form

$$u {-}^{1} {u}_{i} {-}^{1} {u}_{j}$$

$$or$$

$$u {-}^{2} {u}_{i} {-}^{1} {u}_{j}$$

with uᵢ, uⱼ∈U′, where the number above the dash denotes the time period of the edge. For the former possibility of

$$u {-}^{1} {u}_{i} {-}^{1} {u}_{j} ,$$

there are α₁Δ such edges

$$u {-}^{1} {u}_{i}$$

(i.e., intra-community edges from u in period 1), and for each node uᵢ∈U′, there are also ∝₁Δ edges of the form

$${u}_{i} {-}^{1} {u}_{j}$$

to some node uⱼ∈U′. Hence the total number of

$$u {-}^{1} {u}_{i} {-}^{1} {u}_{j}$$

paths is the product α₁²Δ², and since both edges in such paths are in period 1, there is no time decay. For the latter possibility of

$$u {-}^{2} {u}_{i} {-}^{1} {u}_{j} ,$$

there are α₂Δ edges

$$u {-}^{2} {u}_{i}$$

(intra-community edges from u in period 2), and through each of these edges, there are α₁Δ such paths

$$u {-}^{2} {u}_{i} {-}^{1} {u}_{j} ;$$

hence the total number of such paths is α₁α₂Δ², and due to time decay, their total contribution is γα₁α₂Δ². Therefore, the sum of the (U′×U′)₁ block of xᵤ is (α₁²+γα₁α₂)Δ². It follows that the sum of the (U′×U′)₁ block of \tilde{x}ᵤ is

$$( 1 / ( 2 Δ ) ) ( {α}_{1}^{2} + γ {α}_{1} {α}_{2} ) {Δ}^{2} = ( {α}_{1}^{2} + γ {α}_{1} {α}_{2} ) \frac{Δ}{2} .$$

Since there are

$${α}_{1} \frac{Δ n}{4}$$

edges in (U′×U′)₁, the expected value of an entry in this block is (α₁+γα₂)(2/n).

Second, consider the (V′×V′)₁ block of xᵤ. Contributions to this block must come from paths of the form

$$u {-}^{1} {v}_{i} {-}^{1} {v}_{j}$$

$$or$$

$$u {-}^{2} {v}_{i} {-}^{1} {v}_{j}$$

with vᵢ, vⱼ∈V′. For the former possibility of

$$u {-}^{1} {v}_{i} {-}^{1} {v}_{j} ,$$

there are (1−α₁)Δ such edges

$$u {-}^{1} {v}_{i}$$

(i.e., intra-community edges from u in period 1), and for each node vᵢ ∈V′, there are also ∝₁Δ edges of the form

$${v}_{i} {-}^{1} {v}_{j}$$

to some node vⱼ∈V′. (intra-community edges from vᵢ in period 1). Hence the total number of

$$u {-}^{2} {v}_{i} {-}^{1} {v}_{j}$$

paths is the product α₁(1−α₁)Δ², and since both edges in such paths are in period 1, there is no time decay. For the latter possibility of

$$u {-}^{2} {v}_{i} {-}^{1} {v}_{j} ,$$

there are (1−α₂)Δ edges

$$u {-}^{2} {v}_{i}$$

(inter-community edges from u in period 2), and through each of these edges, there are α₁Δ such paths

$$u {-}^{2} {v}_{i} {-}^{1} {v}_{j} ;$$

hence the total number of such paths is α₁(1−α₂)Δ², and due to time decay, their total contribution is γα₁(1−α₂)Δ². Therefore, the sum of the (V′×V′)₁ block of xᵤ is (α₁(1−α₁)+γα₁(1−α₂))Δ². As before, it follows that the expected value of an entry in the (V′×V′)₁ block of \tilde{x}ᵤ, which also contains

$${α}_{1} \frac{Δ n}{4}$$

edges/entries, is ((1−α₁)+γ(1−α₂))(2/n).

Third, consider the (U′×V′)₁ block of xᵤ. Contributions to this block must come from paths of the form

$$u {-}^{1} {u}_{i} {-}^{1} {v}_{i} ,$$

$$u {-}^{1} {v}_{i} {-}^{1} {u}_{i} ,$$

$$u {-}^{2} {u}_{i} {-}^{1} {v}_{i} ,$$

$$or$$

$$u {-}^{2} {v}_{i} {-}^{1} {u}_{i} ,$$

with uᵢ∈U′ and vᵢ∈V′. As before, we sum the contributions each kind of path, yielding:

$$( {α}_{1} ( 1 - {α}_{1} ) + {( 1 - {α}_{1} )}^{2} + γ {α}_{2} ( 1 - {α}_{1} ) + γ ( 1 - {α}_{2} ) ( 1 - {α}_{1} ) ) {Δ}^{2} = ( 1 + γ ) ( 1 - {α}_{1} ) {Δ}^{2}$$

for the sum of the (U′×V′)₁ block of xᵤ. It follows that the expected value of an entry in the (U′×V′)₁ block of \tilde{x}ᵤ which contains

$$( 1 - {α}_{1} ) \frac{Δ n}{2} edges / entries ,$$

$$is$$

$$( 1 + γ ) ( 1 / n ) .$$

Note that the expected values of entries in the (U′×U′)₂, (V′×V′)₂, and (U′×V′)₂ follow from these results by symmetry, by simply swapping α₁ and α₂. The embedding \tilde{x}ᵥ for the node in V also follows by symmetry. We can finally write the block structure of the mean-edge node embeddings \tilde{x}ᵤ and \tilde{x}ᵥ for these nodes. As with the expected time-decayed line graph adjacency matrix Z discussed above, the blocks are constant in value, and these values are given by 2/n times

$$\begin{matrix} & \begin{matrix}{( {U}^{′} \times {U}^{′} )}_{1} & {( {U}^{′} \times {U}^{′} )}_{2} & {( {V}^{′} \times {V}^{′} )}_{1} & {( {V}^{′} \times {V}^{′} )}_{2} & {( {U}^{′} \times {V}^{′} )}_{1} & {( {U}^{′} \times {V}^{′} )}_{2}\end{matrix} \\ \begin{matrix}u \\ \\ v\end{matrix} & ( \begin{matrix}{α}_{1} & {α}_{2} & ( 1 - {α}_{1} ) & ( 1 - {α}_{2} ) & & \\ + γ {α}_{2} & + γ {α}_{1} & \begin{matrix}+ γ \\ ( 1 - {α}_{2} )\end{matrix} & \begin{matrix}+ γ \\ ( 1 - {α}_{1} )\end{matrix} & \frac{1}{2} ( 1 + γ ) & \frac{1}{2} ( 1 + γ ) \\ ( 1 - {α}_{1} ) & ( 1 - {α}_{2} ) & {α}_{1} & {α}_{2} & & \\ \begin{matrix}+ γ \\ ( 1 - {α}_{2} )\end{matrix} & \begin{matrix}+ γ \\ ( 1 - {α}_{1} )\end{matrix} & + γ {α}_{2} & + γ {α}_{1} & \frac{1}{2} ( 1 + γ ) & \frac{1}{2} ( 1 + γ )\end{matrix} )\end{matrix}$$

As desired, the embeddings for nodes u and v are distinct as long as both γ≠1 and it is not the case that α₁=α₂=½. Note that, as discussed above, the embeddings are not distinct if γ=1 and α₁+α₂=1.

In sum, the above discussion provides an explanation of part of the expected block structure of the resulting node embeddings X, similar to the preceding description of the time-decayed line graph system adjacency matrix A. When time decay is not applied (i.e., by setting γ=1), the nodes in U and V become indistinguishable in the derived embeddings for temporal graph unions with α₁+α₂=1, as opposed to just when α₁=α₂=½. These are temporal graph unions similar to image 506 in FIG. 5, which has a community structure when considering time, but becomes an Erdös-Rényi graph when ignoring time.

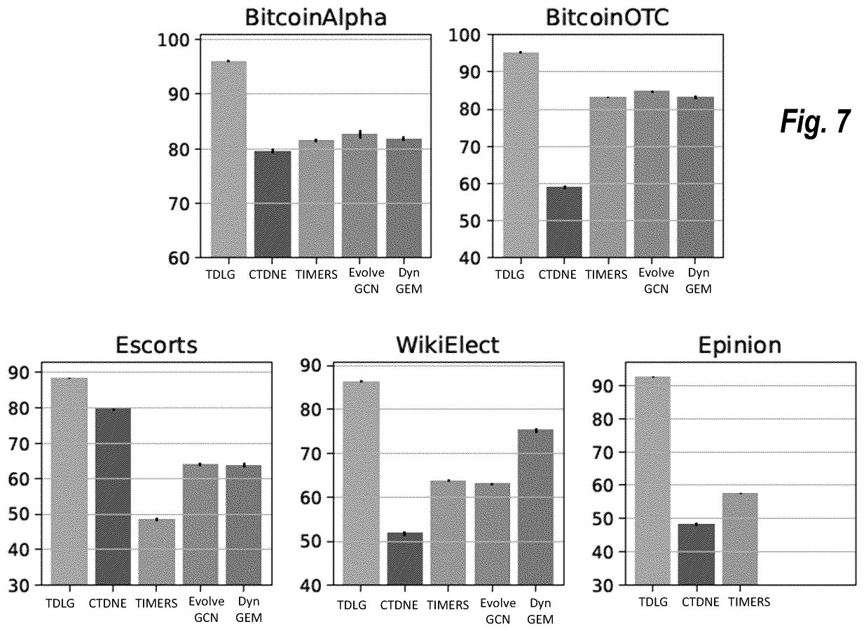

As mentioned, the time-decayed line graph system 106 shows improved accuracy over multiple downstream predictive modeling tasks such as edge classification and temporal link predication (e.g., interpolative temporal link prediction and extrapolative temporal link prediction). Indeed, as illustrated in FIGS. 7-12, the time-decayed line graph system 106 (TDL) compares markedly better on downstream predictive modeling tasks than Cross-Temporal Dynamic Network Embedding (CTDNE), Temporal Interaction Mining via Embedding and Regularization on Structural Dynamics (TIMERS), Evolving Graph Convolutional Networks for Dynamic Graphs (EvolveGCN), Dynamic Graph Embedding with Motifs (DynGEM), GCRN (Graph Convolutional Recurrent Network), and VGRNN (Variational Graph Generative Network) for real world datasets (e.g., BitcoinAlpha, BitcoinOTC, Escorts, WikiElect, and Epinion).

In particular, as shown in FIGS. 7-12, in one or more exemplary implementations and to evaluate the time-decayed line graph system 106 as compared to the conventional systems listed above and the time-decayed line graph system 106 uses a machine learning model (e.g., logistic regression classifier) to which the input is a feature vector for each edge of the network and the target is a binary edge class. The time-decayed line graph system 106 makes random 70%/30% splits of training/test data, and reports test AUC of binary classification across 10 trials with 10 random splits. Notably, the other methods output 128-dimensional dense embeddings, unlike the time-decayed line graph system 106, which outputs m-dimensional sparse embeddings; for an additional, direct comparison, results are also included for using the top 128 eigenvectors (i.e., those with highest magnitude eigenvalues) of the time-decayed line graph system 106 adjacency matrix (‘TDLG Dense’). With the exception of the time-decayed line graph system 106 and CTDNE, all other methods do not directly handle the continuous time stamps of the datasets; for these methods, the results are generated by slotting the edges into discrete snapshots by evenly dividing the full-time span into 20 intervals. All experiments were run on a Xeon Gold 6130 CPU and Tesla v100 16 GB GPU; only the latter four methods listed above (i.e., the deep methods) use the GPU, and the four methods were not tested on EPINIONS due to GPU memory limitations.

In particular, for all embedding methods, in the exemplary implementations, the tests were run using the scikit-learn implementation of logistic regression; and increasing the maximum iterations to 103, and, since the edge classes are generally imbalanced across the datasets, the class_weight option was set to ‘balanced,’ which adjusts loss weights inversely in proportion to class frequency. For the time-decayed line graph, the time scale hyperparameter σₜ was set as ratio of the standard deviation of the edges' times; calling this standard deviation be Or, the tests used σₜ=10⁻¹·σ_{T}, which was chosen by informal tuning. For the EPINIONS dataset only, the solver for sparse logistic regression was modified to the ‘saga’ solver, which is more scalable than the default ‘lbfgs’ solver, and the maximum number of iterations was reduced to 100 (the default value).

Specifically, FIG. 7 illustrates the improved accuracy of an exemplary implementation of the time-decayed line graph system 106 as evaluated by Area Under the Curve (AUC) metrics on the edge classification task for real-world datasets. Indeed, FIG. 7 illustrates the mean AUC and 95% confidence intervals for the exemplary implementation of the time-decayed line graph system 106 (TDLG), CTDNE, TIMERS, EvolveGCN, and DynGEM on all datasets. In particular, AUC measures the model's ability to distinguish between positive and negative interactions in a network over time. AUC is calculated based on the Receiver Operating Characteristic (ROC) curve, which plots the True Positive Rate (TPR) against the False Positive Rate (FPR) at various classification thresholds. The ROC curve is a compares different models, as it shows how the trade-off between TPR and FPR changes as the threshold is adjusted. AUC ranges from 0 to 100, with a value of 100 indicating perfect classification and a value of 50 indicating random chance. A higher AUC value implies better performance of the binary classification model.

As mentioned, the exemplary implementation of the time-decayed line graph system 106 shows markedly improved accuracy and performance on downstream predictive modeling for real-world datasets when compared to conventional systems, often by a large margin. FIG. 8 illustrates the full experimental results of the exemplary implementation of the time-decayed line graph system 106 performance in downstream predictive modeling tasks. Indeed, FIG. 8 illustrates test AUC on all three tasks mean performance over the evaluated real-world datasets (aggregated across datasets), excluding EPINIONS. In particular, to compactly compare conventional methods across datasets, the performance was aggregated across the datasets and the mean was plotted across all datasets of each method's test AUC (excluding EPINIONS—EPINIONS was excluded since some methods were not able to be run on this dataset due to high memory/resource demand).

For predicted edge classification, as shown, the exemplary implementation of the time-decayed line graph system 106 achieves the highest performance out of all these methods on all datasets; the dense variant of the time-decayed line graph system 106, which perhaps provides more direct comparison with other methods, sees reduced performance, but also outperforms all prior methods.

For temporal link prediction, the data is split into 20 intervals, intervals 1-19 are considered ‘early’ data and interval 20 is considered ‘late’ data. To share computational effort across the two settings, both interpolative temporal link prediction and extrapolative temporal link prediction classifiers are trained on 70% of edges (both positive and negative) from the early intervals. For interpolative temporal link prediction, the test data comprises the remaining 30% of edges from the early intervals and the test edges are in the same time interval as the training edges. For extrapolative temporal link prediction, the test data comprises all edges from the late interval and the test edges are in an interval of time following that of the training data. Evaluating the link prediction task has greater computational cost compared to edge classification since the input graph changes across trials rather than just train/test splits of labels, requiring new embeddings to be made for each trial. For this reason, only 5 selected methods are illustrated. FIG. 8 illustrates the mean AUC and 95% confidence intervals across 5 trials for the exemplary implementation, each trial having different random shuffles producing different negative edges, as well as different 70%/30% train/test splits. Additionally, temporal link prediction generally uses the same hyperparameters as for predicted edge classification, with one exception: since there is an equal number of positive and negative edges, all edges are given equal weight (e.g., class_weight option is not set to ‘balanced’). As for predicted edge classification, FIG. 8 illustrates the aggregated (mean) performance across the datasets, for both the interpolative temporal link prediction and extrapolative temporal link prediction. As shown, in both settings, across all datasets, the time-decayed line graph system 106 achieves the highest performance, often by a large margin.

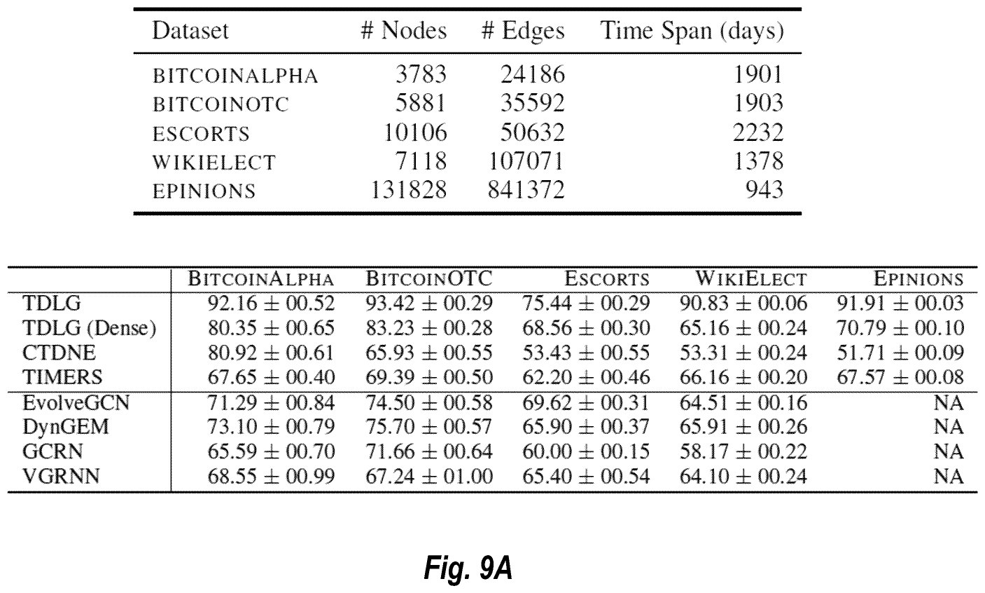

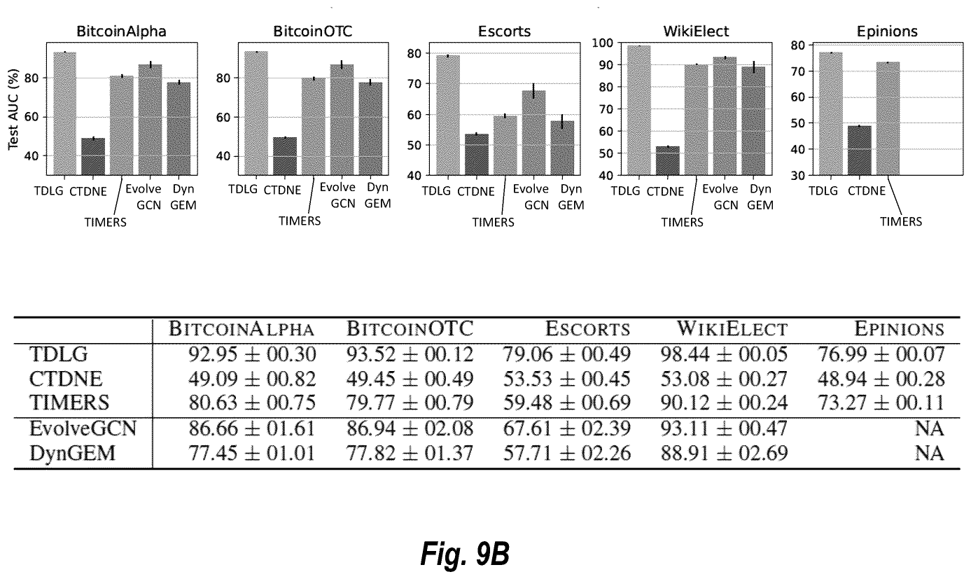

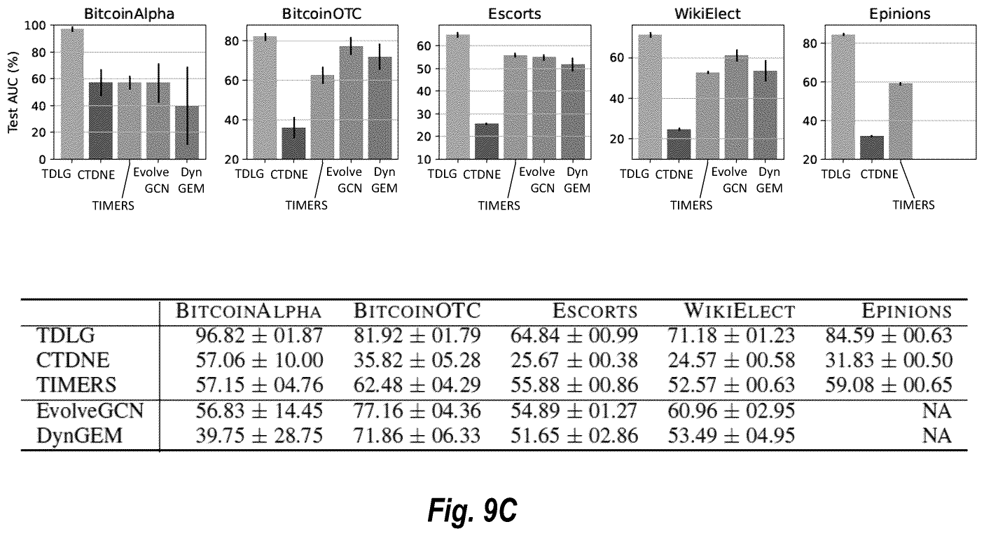

As mentioned, the exemplary implementation of the time-decayed line graph system 106 shows markedly improved accuracy and performance when compared to conventional systems. In particular, as shown in FIGS. 9A-9C, the exemplary implementation of the time-decayed line graph system 106 shows markedly improved accuracy and performance for downstream modeling tasks for real-world datasets when compared to conventional systems. The tests use a collection of 5 temporal network datasets with the statistics shown. Each temporal edge involves one user rating another user's trustworthiness on a scale of −10 to +10 at some point in time; the tests binarize these ratings to positive and nonpositive to produce binary edge labels for classification. BITCOINALPHA and BITCOINOTC (Kumar et al., 2016; 2018) are who-trust-whom networks of people who trade Bitcoin on the Bitcoin Alpha and Bitcoin OTC platforms. ESCORTS is a bipartite network of sexual escorts and buyers; the edges are timed instances of a buyer rating escorts from −1 to +1, which the tests binarize as before. WIKIELECT (Leskovec et al., 2010) is a network of Wikipedia users voting in administrator elections for or against other users to be promoted to administrator. EPINIONS (Leskovec et al., 2010) is a who-trusts-whom network for the now-closed consumer review website Epinions.com.

Specifically, FIG. 9A illustrates the complete results for edge classification in an exemplary implementation using the benchmark of datasets described above: mean test AUC (%), as well as 95% confidence intervals, where the methods are separated by non-deep vs deep. Further, FIG. 9B shows the complete results for temporal link outlier detection (interpolative): mean test AUC (%) and 95% confidence intervals in an exemplary implementation. Further, FIG. 9C shows the complete results for temporal link prediction (extrapolative): mean test AUC (%) and 95% confidence intervals in an exemplary implementation. Notably, across all five datasets, the time-decayed line graph system 106 performs best, often by a significant margin.

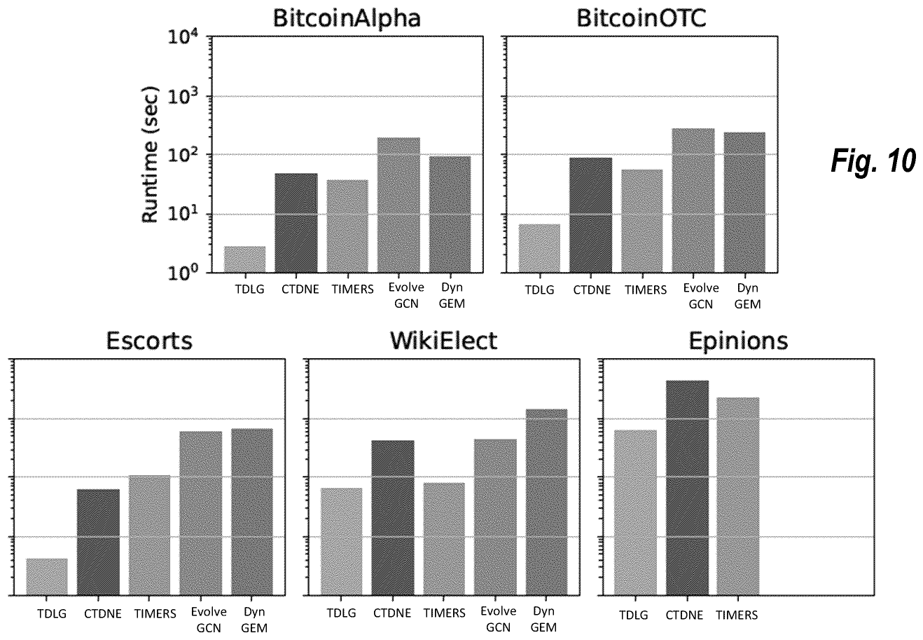

As mentioned, the exemplary implementation of the time-decayed line graph system 106 is more efficient delivering a faster runtime than conventional methods. FIG. 10 illustrates a comparison of the runtime of the exemplary implementation of the time-decayed line graph system 106 and conventional systems when performing edge classification.

Indeed, when evaluating the time efficiency of the exemplary implementation of the time-decayed line graph system 106 against the selected baseline methods, as shown in FIG. 10, the exemplary implementation of the time-decayed line graph system 106 is more computationally efficient. In particular, the mean runtime in seconds for a trial of edge classification is shown. The runtime evaluation constitutes one trial of learning embeddings, based on learning a logistic regression classifier on training data, and predicting on test data. Across all five datasets, the exemplary implementation of the time-decayed line graph system 106 is the fastest, often by a significant margin.

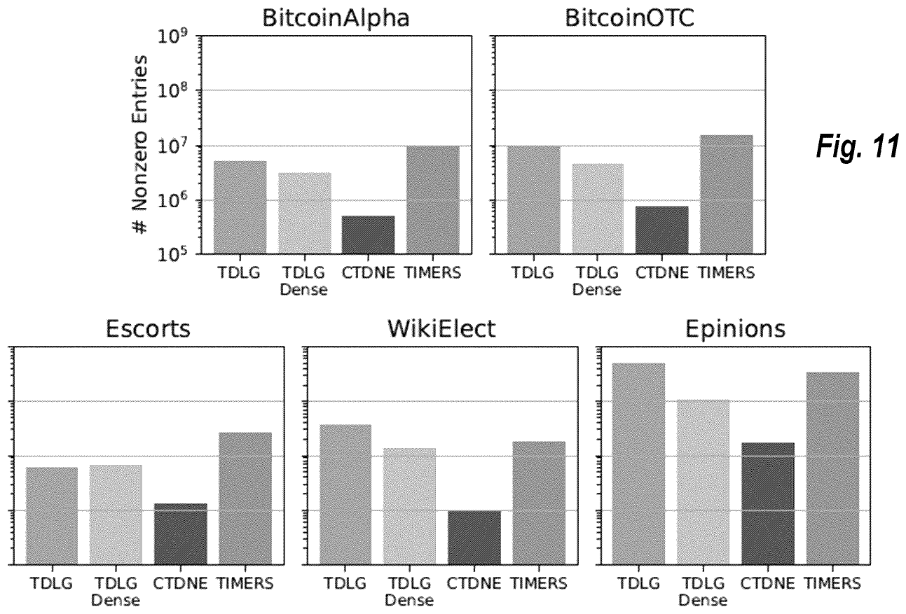

Notably, as shown by FIG. 11, in one or more embodiments, the time-decayed line graph system 106 is scalable. In particular, theory shows that the number of edges in a line graph L(G) of a graph G scales with the sum of squared degrees of the nodes in G. Hence the number of nonzero entries in the adjacency matrix A of the time-decayed line graph system 106 scales with the same quantity Σᵢdᵢ and this determines both the memory requirement of storing the time-decayed line graph, as well as the asymptotic runtime of methods based on multiplying by A, including training a logistic regression classifier and truncated SVD (i.e., Singular Value Decomposition, calculating the top eigenvectors), since the time complexity of matrix multiplication by a sparse matrix scales linearly with the number of nonzero entries. Scaling on real-world distributions has shown to be computationally practical, including up to the large EPINIONS dataset of over 800K edges. For example, in an exemplary embodiment, the time-decayed line graph system 106 runs EPINIONS on a standard 16 GB laptop, which is not possible with many conventional methods.

Indeed, the numbers of nonzero entries in the embeddings generated by the time-decayed line graph system 106 are comparable to those generated by TIMERS and deep methods. As shown in FIG. 11, in an exemplary implementation, despite the simplicity of the time-decayed line graph system 106, the number of nonzero entries in the embeddings generated by the time-decayed line graph system 106 and conventional methods for each dataset are comparable when using the hyperparameter settings outlined above. CTDNE generally has lighter embeddings because it stores a single dense vector per node (although, as shown, a dense vector representation such as that used by CTDNE can inaccurately capture the dynamic nature of the relationships between nodes over time).

To scale the time-decayed line graph system 106 to much larger datasets of millions of edges, there are several additional possible implementations. In one or more embodiments, some edges will share an endpoint but be very far apart in time. Hence, the entry corresponding to such pairs of edges will be nonzero but very small and these entries are ignored or removed. In one or more embodiments, it is not necessary to hold the entire matrix for the time-decayed line graph system 106 in memory at once: given the closed-form formula, it is possible to construct some rows and supply them to a stochastic solver on-the-fly. In one or more embodiments, because each column can be deemed a feature, only certain columns are sampled (e.g., by leverage score sampling) without a significant drop in performance. In one or more embodiments, scalability is increased via a reduction of the number of features. The time-decayed line graph system 106 method returns m features per temporal edge based on proximities to all other temporal edges. It is possible to efficiently reduce the feature space by only considering proximities to certain edges (e.g., edges with higher effective resistances). In one or more embodiments, feature space is reduced by efficiently forming a low-rank representation of the time-decayed line graph system 106 adjacency matrix (e.g., via a stochastic method).

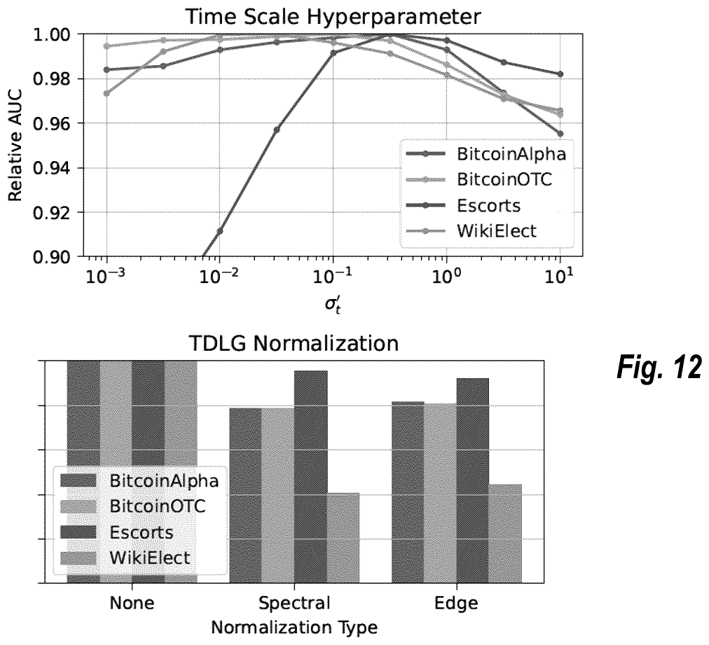

As previously mentioned, in some implementations the time-decayed line graph system 106 sets the hyperparameter or as the ratio of the standard deviation of the edges' times. FIG. 12 illustrates how the time-decayed line graph system 106 performance is impacted when varying the time scale hyperparameter (e.g., σ′ₜ∈[10⁻³, 10⁺¹]) or normalization type. Letting the standard deviation be σ_{T}, the time-decayed line graph system 106 uses σₜ:=σ′ₜ·σ_{T}. In particular, the value of 10⁻¹ for σₜ appears to work well for one or more implementations of the time-decayed line graph system 106 for the tested datasets (e.g., chosen from the natural values of 10⁻², 10⁻¹, and 10⁰). Indeed, across the tested datasets (BITCOINALPHA, BITCOINOTC, ESCORTS, and WIKIELECT), the highest test performance indeed occurs near σ′ₜ=10⁻¹, though there is some variance in the optimal value across datasets. Performance is also robust with respect to this hyperparameter: for all tested datasets except ESCORTS, performance does not fall more than 5% relative to the best value of σ′ₜ as it is varied across the tested range.

In one or more embodiments, the time-decayed line graph system 106 does not require normalization and efficiently generates a time-decayed line graph without an additional normalization step. FIG. 12 illustrates the impact of spectral and edge normalization on the time-decayed line graph system 106 for the predicted edge classification task.

In particular, for spectral normalization as illustrated in FIG. 12, let D∈ [symbol] ₊^{m×m} denote the diagonal degree matrix, the diagonal entries of which are the row sums of A (which are equivalent to the column sums). Spectral normalization sets the normalized matrix to:

$$Ã = {D}^{- 1 / 2} {AD}^{- 1 / 2} .$$

This normalization has useful spectral properties, bounding eigenvalues within [−1, +1].

The edge normalization procedure aims to roughly preserve the total amount of edge weight associated with each edge. Edge normalization assumes that the original temporal graph is unweighted, meaning each edge weight is 1, and seeks for each row/column sum of the time-decayed line graph system 106 adjacency matrix to also be approximately 1. In particular, edge normalization as illustrated in FIG. 12 sets

$$Ã = \frac{1}{2} ( {D}^{- 1} + {AD}^{- 1} ) ,$$

that is, edge normalization returns the mean of the two matrices that result from dividing the rows/columns of A by the row/column sums. Note that this normalization preserves symmetry of the adjacency matrix. Edge normalization guarantees rough preservation of edge weight as follows: because each row of D⁻¹A sums to 1, each row of Ã sums to at least ½; further, since there are m rows, the total sum of all entries in D⁻¹A is m; similarly, AD⁻¹ sums to m as well, so Ã sums to m. Therefore, each edge, which in the original temporal graph was given exactly fraction 1/m of the total edge weight, is assigned at least fraction ½m of the total weight in the normalized time-decayed line graph.

As illustrated in FIG. 12, across the tested datasets, both normalization schemes (e.g., spectral normalization and edge normalization) generally have a negative impact on the performance of the time-decayed line graph system 106, though the drop in performance is never more than around 6%. These results suggest that the approach of skipping normalization is generally the most performant for one or more embodiments of time-decayed line graph system 106. Turning now to FIG. 13, additional detail will now be provided regarding various components and capabilities of the time-decayed line graph system 106. In particular, FIG. 13 illustrates the time-decayed line graph system 106 implemented by the computing device 1300 (e.g., the server(s) 102 and/or one of the client devices 110a-110n discussed above with reference to FIG. 1). Additionally, the time-decayed line graph system 106 is also part of the interaction analysis system 104. As shown in FIG. 13, the time-decayed line graph system 106 includes, but is not limited to, a temporal graph manager 1302, a time-decayed line graph manager 1304, a downstream prediction manager 1306, and a data storage manager 1308.

As just mentioned, and as illustrated in FIG. 13, the time-decayed line graph system 106 includes the temporal graph manager 1302. In one or more embodiments, the temporal graph manager 1302 generates a temporal graph network comprising multiple entity nodes and temporal interaction edges connecting the entity nodes. As mentioned above, the time-decayed line graph system learns natural continuous-time edge embeddings and constructs time-decayed line graphs by composing nodes from each interaction on the temporal graph network, deriving edge embeddings from the continuous-time representation of the data, and decaying edge weights based on the difference in time between interactions.

Additionally, as shown in FIG. 13, the time-decayed line graph system 106 includes the time-decayed line graph manager 1304. As mentioned above, the time-decayed line graph manager 1304 constructs a time-decayed line graph from the temporal graph network by generating interaction nodes from temporal interaction edges of the temporal graph network and generating time-decayed weighted edges between the interaction nodes where the time-decayed weight is based on temporal information associated with the temporal interaction edges. For example, in some cases, the time-decayed line graph manager generates a time-decayed weight inversely proportional to a difference in interaction time of the temporal interaction edges.

As further shown in FIG. 13, the time-decayed line graph system 106 includes the downstream prediction manager 1306. In one or more embodiments, the downstream prediction manager 1306 generates predicted edge classifications and/or temporal link predictions. For instance, in some implementations, the downstream prediction manager 1306 generates continuous-time edge embeddings (vector representations) from the time-decayed line graph to learn the timed interactions between entities. For example, the downstream prediction manager 1306 trains a classification machine learning model based on continuous-time edge embeddings to generate predicted edge classifications and/or temporal link predictions.

Additionally, as shown, the time-decayed line graph system 106 includes data storage manager 1308. In particular, data storage manager 1308 (implemented by one or more memory devices) stores the machine learning models, temporal graph networks (including entity nodes and temporal interaction edges), time-decayed line graphs (including interaction nodes and time-decayed weighted edges), vector representations, time-decayed line graph matrixes, predicted edge classifications, and temporal link predictions.

Each of the components 1302-1308 of the time-decayed line graph system 106 can include software, hardware, or both. For example, the components 1302-1308 can include one or more instructions stored on a computer-readable storage medium and executable by processors of one or more computing devices, such as a client device or server device. When executed by the one or more processors, the computer-executable instructions of the time-decayed line graph system 106 can cause the computing device(s) to perform the methods described herein. Alternatively, the components 1302-1308 can include hardware, such as a special-purpose processing device to perform a certain function or group of functions. Alternatively, the components 1302-1308 of the time-decayed line graph system 106 can include a combination of computer-executable instructions and hardware.

Furthermore, the components 1302-1308 of the time-decayed line graph system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1302-1308 of the time-decayed line graph system 106 may be implemented as a stand-alone application, such as a desktop or mobile application. Furthermore, the components 1302-1308 of the time-decayed line graph system 106 may be implemented as one or more web-based applications hosted on a remote server. Alternatively, or additionally, the components 1302-1308 of the time-decayed line graph system 106 may be implemented in a suite of mobile device applications or “apps.” For example, in one or more embodiments, the time-decayed line graph system 106 can comprise or operate in connection with digital software applications such as ADOBE TARGET, ADOBE EXPERIENCE PLATFORM (AEP), ADOBE ANALYTICS, ADOBE CAMPAIGN, ADOBE® SOCIAL, ADOBE® DOCUMENT CLOUD, ADOBE E-COMMERCE, ADOBE MAGENTO, ADOBE DATA PLATFORM, ADOBE MARKETING CLOUD, ADOBE EXPERIENCE CLOUD, or ADOBE BEHANCE. The foregoing are either registered trademarks or trademarks of Adobe Inc. in the United States and/or other countries.

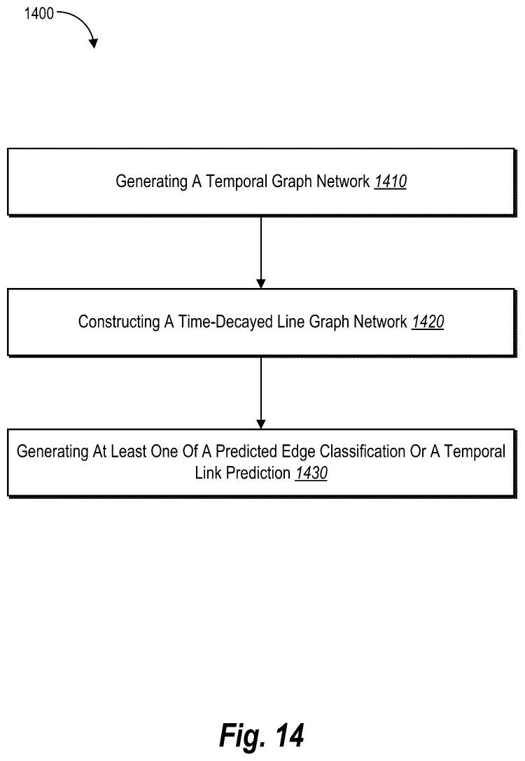

FIGS. 1-13, the corresponding text, and the examples provide a number of different methods, systems, devices, and non-transitory computer-readable media of the time-decayed line graph system 106. In addition to the foregoing, one or more embodiments can also be described in terms of flowcharts comprising acts for accomplishing a particular result, as shown in FIG. 14. The acts shown in FIG. 14 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 14. In some embodiments, a system can be configured to perform the acts of FIG. 14. Alternatively, the acts of FIG. 14 can be performed as part of a computer-implemented method.

As mentioned above, FIG. 14 illustrates a flowchart of a series of acts 1400 for generating downstream predictive modeling with a time-decayed line graph system 106 in accordance with one or more embodiments. While FIG. 14 illustrates acts according to one embodiment, alternative embodiments may omit, add to, reorder, and/or modify any acts shown in FIG. 14.

FIG. 14 illustrates an example series of acts 1400 for utilizing a time-decayed line graph system to generate a time-decayed line graph in accordance with one or more embodiments. In particular, the series of acts 1400 includes an act 1410 of generating a temporal graph network. Specifically, the act 1410 can include generating a temporal graph network comprising a plurality of entity nodes and temporal interaction edges connecting the plurality of entity nodes.

As illustrated, the series of acts 1400 can also include an act 1420 of constructing a time-decayed line graph network. In particular, the act 1420 can include constructing a time-decayed line graph from the temporal graph network by generating interaction nodes from temporal interaction edges of the temporal graph network and generating time-decayed weighted edges between the interaction nodes based on times of the temporal interaction edges.

Moreover, as shown in FIG. 14, the series of acts 1400 can include the act 1430 generating a at least one of a predicted edge classification or a temporal link prediction. In particular, the act 1430 can include generating a at least one of a predicted edge classification or a temporal link prediction utilizing the time-decayed line graph.

In addition (or in the alternative) to the acts described above, the series of acts 1400 can include generating the temporal graph network by generating the temporal interaction edges reflecting continuous times corresponding to entity interactions; and constructing the time-decayed line graph comprising generating the interaction nodes and time-decayed weighted edges from the continuous times corresponding to the temporal interaction edges. Moreover, in one or more embodiments, the series of acts 1400 includes generating at least one of the predicted edge classification or the temporal link prediction by generating continuous-time edge embeddings from the time-decayed line graph; and generating the at least one of the predicted edge classification or the temporal link prediction from the continuous-time edge embeddings.

Further still, in some embodiments, the series of acts 1400 includes constructing the time-decayed line graph by generating a first interaction node from a first temporal interaction edge of the temporal graph network and corresponding to a first interaction time; and generating a second interaction node from a second temporal interaction edge of the temporal graph network and corresponding to a second interaction time. Moreover, in one or more embodiments, the series of acts 1400 includes constructing the time-decayed line graph based on determining that the first temporal interaction edge and the second temporal interaction edge are connected to a shared entity node of the temporal graph network, generating a time-decayed weighted edge between the first interaction node and the second interaction node.

In addition, in one or more embodiments, the series of acts 1400 includes generating the time-decayed weighted edge by determining a time-decayed weight for the time-decayed weighted edge based on the first interaction time and the second interaction time. Moreover, in one or more embodiments, the series of acts 1400 includes generating a time-decayed weight inversely proportional to a difference between the first interaction time and the second interaction time.

Further still, in one or more embodiments, the series of acts 1400 includes generating the predicted edge classification by generating a vector representation from the time-decayed weighted edges; and generating, utilizing a classification machine learning model trained on a set of vector representations and ground truth labels, the predicted edge classification from the vector representation from the time-decayed weighted edges. Moreover, in one or more embodiments, the series of acts 1400 includes generating the temporal link prediction by generating a vector representation from the time-decayed weighted edges; and generating, utilizing a binary temporal link classification machine learning model trained on positive vector representations and negative vector representations of historical time-decayed weighted edges, a binary temporal link prediction.

Moreover, in one or more embodiments, the series of acts 1400 includes generating a first interaction node from a first temporal interaction edge of the temporal graph network and corresponding to a first interaction time; generating a second interaction node from a second temporal interaction edge of the temporal graph network and corresponding to a second interaction time; based on determining that the first temporal interaction edge and the second temporal interaction edge are connected to an entity node of the temporal graph network, generating a time-decayed weighted edge between the first interaction node and the second interaction node; and determining a time-decayed weight for the time-decayed weighted edge based on the first interaction time and the second interaction time.

Further still, in one or more embodiments, the series of acts 1400 includes generating a continuous-time edge embedding from the time-decayed weighted edge; and generating at least one of a predicted edge classification or a temporal link prediction utilizing the time-decayed weighted edge. Moreover, in one or more embodiments, the series of acts 1400 includes generating a third interaction node from a third temporal interaction edge of the temporal graph network and corresponding to a third interaction time; and based on determining that the third temporal interaction edge is connected to the entity node of the temporal graph network, generating a second time-decayed weighted edge between the first interaction node and the third interaction node.

In addition, in one or more embodiments, the series of acts 1400 includes generating a continuous-time edge embedding from the time-decayed weighted edge and a second continuous-time edge embedding from the second time-decayed weighted edge. Moreover, in one or more embodiments, the series of acts 1400 includes determining a time difference between the first interaction time and the second interaction time; and determining the time-decayed weight for the time-decayed weighted edge inversely proportional to the time difference. Additionally, in one or more embodiments, the series of acts 1400 includes generating a vector representation from the time-decayed weighted edge; and generating, using a machine learning model trained on the vector representation, at least one of a predicted edge classification or a temporal link prediction.

Further still, in one or more embodiments, the series of acts 1400 includes generating a temporal graph network comprising a plurality of entity nodes and temporal interaction edges connecting the plurality of entity nodes; constructing a time-decayed line graph from the temporal graph network by: generating a first interaction node from a first temporal interaction edge connected to an initial entity node and corresponding to a first interaction time; generating a second interaction node from a second temporal interaction edge connected to the initial entity node and corresponding to a second interaction time; and generating a time-decayed weighted edge between the first interaction node and the second interaction node based on the first interaction time and the second interaction time; and generating at least one of a predicted edge classification or a predicted temporal link utilizing the time-decayed line graph.

Moreover, in one or more embodiments, the series of acts 1400 includes generating the first temporal interaction edge comprising a first continuous time corresponding to a first interaction; generating a second temporal interaction edge to reflect a second continuous time corresponding to a second interaction; and generating the time-decayed weighted edge based on the first continuous time of the first temporal interaction edge and the second continuous time of the second temporal interaction edge. In addition, in one or more embodiments, the series of acts 1400 includes generating a vector representation from the time-decayed weighted edge; and generating, utilizing a classification machine learning model, a predicted edge classification or a binary temporal link prediction from the vector representation from the time-decayed weighted edge. Further still, in one or more embodiments, the series of acts 1400 includes generating a time-decayed weight for the time-decayed weighted edge based on the first interaction time and the second interaction time wherein the time-decayed weight is inversely proportional to a difference between the first interaction time and the second interaction time.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., server device(s) 102, client devices 110a-110n, and computing device(s) 1300). In one or more embodiments, the computing device 1500 may be a mobile device (e.g., a mobile telephone, a smartphone, a PDA, a tablet, a laptop, a camera, a tracker, a watch, a wearable device, etc.). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 includes storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating a temporal graph network comprising a plurality of entity nodes and temporal interaction edges connecting the plurality of entity nodes;
constructing a time-decayed line graph from the temporal graph network by:
generating interaction nodes from temporal interaction edges of the temporal graph network; and
generating time-decayed weighted edges between the interaction nodes based on times of the temporal interaction edges; and
generating at least one of a predicted edge classification or a temporal link prediction utilizing the time-decayed line graph.

2. The computer-implemented method of claim 1, wherein:
generating the temporal graph network comprises generating the temporal interaction edges reflecting continuous times corresponding to entity interactions; and
constructing the time-decayed line graph comprises generating the interaction nodes and time-decayed weighted edges from the continuous times corresponding to the temporal interaction edges.

3. The computer-implemented method of claim 2, wherein generating the at least one of the predicted edge classification or the temporal link prediction comprises:
generating continuous-time edge embeddings from the time-decayed line graph; and
generating the at least one of the predicted edge classification or the temporal link prediction from the continuous-time edge embeddings.

4. The computer-implemented method of claim 1, wherein constructing the time-decayed line graph comprises:
generating a first interaction node from a first temporal interaction edge of the temporal graph network and corresponding to a first interaction time; and
generating a second interaction node from a second temporal interaction edge of the temporal graph network and corresponding to a second interaction time.

5. The computer-implemented method of claim 4, wherein constructing the time-decayed line graph comprises based on determining that the first temporal interaction edge and the second temporal interaction edge are connected to a shared entity node of the temporal graph network, generating a time-decayed weighted edge between the first interaction node and the second interaction node.

6. The computer-implemented method of claim 5, wherein generating the time-decayed weighted edge comprises determining a time-decayed weight for the time-decayed weighted edge based on the first interaction time and the second interaction time.

7. The computer-implemented method of claim 6, wherein determining the time-decayed weight comprises generating the time-decayed weight inversely proportional to a difference between the first interaction time and the second interaction time.

8. The computer-implemented method of claim 1, wherein generating the predicted edge classification comprises:
generating a vector representation from the time-decayed weighted edges; and
generating, utilizing a classification machine learning model trained on a set of vector representations and ground truth labels, the predicted edge classification from the vector representation from the time-decayed weighted edges.

9. The computer-implemented method of claim 1, wherein generating the temporal link prediction comprises:
generating a vector representation from the time-decayed weighted edges; and
generating, utilizing a binary temporal link classification machine learning model trained on positive vector representations and negative vector representations of historical time-decayed weighted edges, a binary temporal link prediction.

10. A system comprising:
one or more memory devices comprising a temporal graph network comprising a plurality of entity nodes and temporal interaction edges connecting the plurality of entity nodes; and
one or more servers configured to cause the system to generate a time-decayed line graph by:
generating a first interaction node from a first temporal interaction edge of the temporal graph network and corresponding to a first interaction time;
generating a second interaction node from a second temporal interaction edge of the temporal graph network and corresponding to a second interaction time;
based on determining that the first temporal interaction edge and the second temporal interaction edge are connected to a shared entity node of the temporal graph network, generating a time-decayed weighted edge between the first interaction node and the second interaction node; and
determining a time-decayed weight for the time-decayed weighted edge based on the first interaction time and the second interaction time.

11. The system of claim 10, wherein the first temporal interaction edge reflects a first continuous time and the second temporal interaction edge reflects a second continuous time and wherein the one or more servers are further configured to cause the system to generate the time-decayed weighted edge based on the first continuous time and the second continuous time.

12. The system of claim 11, where the one or more servers are further configured to cause the system to:
generate a continuous-time edge embedding from the time-decayed weighted edge; and
generate at least one of a predicted edge classification or a temporal link prediction utilizing the time-decayed weighted edge.

13. The system of claim 11, where the one or more servers are further configured to cause the system to generate the time-decayed line graph by:
generating a third interaction node from a third temporal interaction edge of the temporal graph network and corresponding to a third interaction time; and
based on determining that the third temporal interaction edge is connected to the shared entity node of the temporal graph network, generating a second time-decayed weighted edge between the first interaction node and the third interaction node.

14. The system of claim 13, where the one or more servers are further configured to cause the system to generate a continuous-time edge embedding from the time-decayed weighted edge and a second continuous-time edge embedding from the second time-decayed weighted edge.

15. The system of claim 10, where the one or more servers are further configured to cause the system to:
determine a time difference between the first interaction time and the second interaction time; and
determine the time-decayed weight for the time-decayed weighted edge inversely proportional to the time difference.

16. The system of claim 15, where the one or more servers are further configured to cause the system to:
generate a vector representation from the time-decayed weighted edge; and
generate, using a machine learning model trained on the vector representation, at least one of a predicted edge classification or a temporal link prediction.

17. A non-transitory computer readable medium storing executable instructions which, when executed by a processing device, cause the processing device to perform operations comprising:
generating a temporal graph network comprising a plurality of entity nodes and temporal interaction edges connecting the plurality of entity nodes;
constructing a time-decayed line graph from the temporal graph network by:
generating a first interaction node from a first temporal interaction edge connected to an initial entity node and corresponding to a first interaction time;
generating a second interaction node from a second temporal interaction edge connected to the initial entity node and corresponding to a second interaction time; and
generating a time-decayed weighted edge between the first interaction node and the second interaction node based on the first interaction time and the second interaction time; and
generating at least one of a predicted edge classification or a predicted temporal link utilizing the time-decayed line graph.

18. The non-transitory computer readable medium of claim 17, wherein generating the temporal graph network comprises:
generating the first temporal interaction edge comprising a first continuous time corresponding to a first interaction;
generating a second temporal interaction edge to reflect a second continuous time corresponding to a second interaction; and
generating the time-decayed weighted edge based on the first continuous time of the first temporal interaction edge and the second continuous time of the second temporal interaction edge.

19. The non-transitory computer readable medium of claim 17, wherein the operations further comprise:
generating a vector representation from the time-decayed weighted edge; and
generating, utilizing a classification machine learning model, a predicted edge classification or a binary temporal link prediction from the vector representation from the time-decayed weighted edge.

20. The non-transitory computer readable medium of claim 17, wherein generating the time-decayed weighted edge comprises generating a time-decayed weight for the time-decayed weighted edge based on the first interaction time and the second interaction time wherein the time-decayed weight is inversely proportional to a difference between the first interaction time and the second interaction time.
